(19) United States
(12) Patent Application Publication
(10) Pub. No.: US 2013/0324074 A1
(43) Pub. Date: Dec. 5, 2013

(54) MOBILITY AID SYSTEM

(71) Applicant: Jeremy Way, North Ryde (AU)

(72) Inventor: Jeremy Way, North Ryde (AU)

(73) Assignee: COMMUNITY CONNECTIONS AUSTRALIA, North Ryde, NSW (AU)

(21) Appl. No.: 13/992,907

(22) PCT Filed: Dec. 9, 2011
(86) PCT No.: PCT/AU11/01596

§ 371 Date: Aug. 22, 2013

(30) Foreign Application Priority Data
Dec. 9, 2010 (AU) 2010905415

(51) Int. Cl. H04W 4/02

(52) U.S. Cl. CPC H04W 4/02
USPC 455/404.2; 455/456.1

(57) ABSTRACT

A handheld guide unit for extending the navigational capability of a disabled person; the handheld guide unit including a display unit; and a unit related to time; the handheld guide unit graded as a function of current disability profile of a disabled person.

The present invention relates to a mobility aid system and, more particularly, to some specific components making up such a system applicable, but not exclusively to aid people with disabilities.

### BACKGROUND

Various forms of handheld device are known for assisting people in various ways. The ubiquitous mobile phone is a handheld device initially built to assist in telephonic communication although subsequently providing assistance in many other ways as well.

EP1696302B1 to Research In Motion Limited titled “System and method for making an electronic handheld device more accessible to a disabled person” describes and claims a handheld device designed to provide an interface to a disabled person which thereby renders the device more accessible to that disabled person.

The disclosure of EP1696302B1 is incorporated herein by cross reference.

Problems which persist, particularly but not exclusively in relation to assisting those with disabilities, include the difficulty that disabled people have in transitioning to practical integration into the community. There exists a need for a handheld device which will assist them to improve their capabilities associated with navigation and the like. It is desirable that they can either immediately with the aid of a handheld device or over time with training in part provided by the device itself navigate with confidence about their local and indeed broader community. There is also perceived to be an experiential gap standing in the way of a disabled user transitioning to active engagement (including by way of physical navigation) in their community.

It is an object of the present invention to address or at least ameliorate some of the above disadvantages.

In part the above objects are achieved by a handheld device having the characteristics described in the specification. The objects can also be met with the virtual training system which can work in conjunction with the handheld device.

### Notes

1. The term “comprising” (and grammatical variations thereof) is used in this specification in the inclusive sense of “having” or “including”, and not in the exclusive sense of “consisting only of”.
2. The above discussion of the prior art in the Background of the invention, is not an admission that any information discussed therein is citable prior art or part of the common general knowledge of persons skilled in the art in any country.

### BRIEF DESCRIPTION OF INVENTION

In one broad form of the invention there is provided a handheld guide unit for extending the navigational capability of a disabled person; said unit including display means; prompt means related to time; said unit graded as a function of current disability profile of said disabled person.

In a further one broad form of the invention there is provided a handheld guide unit fox extending the navigational capability of a disabled person; said unit including display means; said unit including prompt means; the functionality of said unit graded as a function of current disability profile of said disabled person.

Preferably the unit includes a communication device adapted to receive an application from a remote location.

Preferably said application includes a tracking application whereby data corresponding to the current location of the handheld guide unit is ascertained by said unit and transmitted to said remote location.

Preferably the unit includes a remote controlled device whereby command data sent from said remote location causes a predetermined command action on said handheld guide unit.

Preferably the unit includes an emergency mode wherein upon manual activation of said emergency mode by a user, said unit displays data for communication to third parties who may assist said user.

Preferably said unit is in communication with a database at a remote location whereby a user of said handheld guide unit can interact with another like user operating a handheld guide unit thereby to interact in a peer-to-peer manner.

Preferably said unit includes a transport module which interfaces with a third party application located on a remote third party database.

Preferably said unit may import a picture either taken by the unit or imported from said database at a remote location and utilises the picture data as an icon displayed on a display of said handheld guide unit.

Preferably said unit further includes a “target achieved” input operable by said user whereby said user may input to said unit the achievement of a predetermined target event thereby, in turn, to prompt programmed next action by said handheld guide unit.

In yet a further broad form of the invention there is provided a virtual community output device for display of educational routines in a programmed sequence to a user.

Preferably said device is programmable in one of a selection of predetermined modes.

Preferably said modes include “Show me”, “Teach me” and “Let me do” mode.

Preferably said display is varied to match the assessed ability of the viewer; said assessment based upon the input and interaction of the user.

In yet a further broad form of the invention there is provided a database system in communication with a virtual communications output device and at least one handheld guide unit; said system sharing at least some items of data between said Virtual Community output device and said handheld guide unit thereby to provide consistency of experience to a user following initial use of said Virtual Community output device and subsequent use of said handheld guide unit.

Preferably modules exhibited on said Virtual Community output device mirror modules exhibited on said handheld device.

In yet a further broad form of the invention there is provided a machine readable medium comprising program code executable on a processor of a handheld guide unit.

In yet a further broad form of the invention there is provided a machine readable medium comprising program code executable on a processor of a Virtual Community output device.

In yet a further broad form of the invention there is provided a virtual telecommunications network adapted for communication with the handheld guide unit incorporating a virtual network identifier insertion module in said handheld unit whereby data packets sent from said unit over a communications network include a virtual network identifier thereby to permit independent control and monitoring of said data packets with reference to said identifier.

Preferably a plurality of said units share a common network identifier thereby to group said data packets.

### BRIEF DESCRIPTION OF DRAWINGS

Embodiments of the present invention will now be described with reference to the accompanying drawings wherein:

FIG. 1 graphically illustrates improvements in capability of a disabled person aimed to be achieved by embodiments of the present invention,

FIG. 2 illustrates diagrammatically the concept of the experiential gap and the components according to embodiments of the present invention which can be utilised to bridge this gap,

FIG. 3A is a block diagram of the components of a typical handheld device programmed to act in accordance with embodiments of the present invention,

FIG. 3B is a diagram of the principal computing, communication and hardware resources that work together from the mobility aid system according to an embodiment of the present invention,

FIG. 4 illustrates diagrammatically cooperative links to be formed between the handheld application, the virtual community and an individual's learning needs when embodiments of the present invention are enlisted,

FIG. 5 is a perspective view of a handheld device in accordance with a preferred embodiment of the present invention,

FIG. 6 illustrates the Diary Screen of the handheld device of FIG. 5,

FIG. 7 illustrates the device of FIG. 5 showing the diary screen in “My Week” view,

FIG. 8 illustrates the device of FIG. 5 with the diary screen in “My Month” view,

FIG. 9 is perspective view of the device of FIG. 5 in “Passerby Assistant” mode,

FIG. 10 illustrates the device of FIG. 5 in “Call” mode,

FIG. 11 illustrates interactivity links between support personnel at a first location and users armed with mobile devices according to embodiments of the present invention at another location,

FIG. 12 illustrates the monitoring and tracking screen useable by support workers,

FIG. 13 illustrates the Home Screen of the device of FIG. 5,

FIG. 14 illustrates a Transport Module Screen of the device of FIG. 5,

FIG. 15 illustrates the Prompt Screen for the device of FIG. 5 when in Transport mode,

FIG. 16 is a further Prompt Screen for the device of FIG. 5 when in Transport Mode,

FIG. 17 is a further Prompt Screen for the device of FIG. 5 when in Transport Mode,

FIG. 18 is a further Prompt Screen for the device of FIG. 5 when in Transport Mode,

FIG. 19 is a further Prompt Screen for the device of FIG. 5 when in Transport Mode,

FIG. 20 is a block diagram of the main components of the mobility aid system in accordance with a further embodiment of the invention,

FIG. 21 illustrates an “Edit Profile” function for the system of FIG. 20,

FIG. 22 illustrates a Contacts Interface for the system of FIG. 20,

FIG. 23 illustrates the Contacts Module for the system of FIG. 20,

FIG. 24 illustrates the Journey Creation Interface for the system of FIG. 20,

FIG. 25 illustrates a further interface for the Journey Module of the system of FIG. 20,

FIG. 26 illustrates a further interface for the Journey Module of the system of FIG. 20,

FIG. 27 is a flow chart, in which a journey is created and edited in the Journey Module of the system of FIG. 20,

FIG. 28 illustrates the map output from the Journey Module from the system of FIG. 20,

FIG. 29 illustrates the Calender Events Log Interface of the system of FIG. 20,

FIG. 30 is an exemplary Log-On page for the Virtual Community according to an embodiment of the present invention,

FIG. 31 is a depiction of “My Suburb” environment page within the Virtual Community of FIG. 30.

FIG. 32 is a screenshot of a handheld device illustrating a “Home Screen” according to an embodiment of the present invention,

FIG. 33 is a screenshot of a handheld device illustrating a “Shortcuts” screen according to an embodiment of the present invention,

FIG. 34 is a screenshot of a handheld device illustrating a “My Day” screen according to an embodiment of the present invention,

FIGS. 35 to 38 are screenshots of a handheld device illustrating “My Trip” screens according to several embodiments of the present invention,

FIG. 39 is a screenshot of a handheld device illustrating a “Now Editing” screen according to an embodiment of the present invention,

FIG. 40 is a screenshot of a handheld device illustrating a “My Friends and Family” screen according to an embodiment of the present invention,

FIG. 41 is a screenshot of a handheld device illustrating a “New Note” screen according to an embodiment of the present invention,

FIG. 42 is a screenshot of a handheld device illustrating an “Emergency” screen according to an embodiment of the present invention,

FIG. 43 is a diagram of the mobility aid system according to an embodiment of the present illustrating use by multiple interest groups,

FIG. 44 illustrates an embodiment invoking an Augmented Reality functionality and QR code functionality,

FIG. 45 is a diagram illustrating the implementation using a Mobile Virtual Network Operator System according to an embodiment of the present invention.

### DETAILED DESCRIPTION OF PREFERRED EMBODIMENTS

### First Embodiment

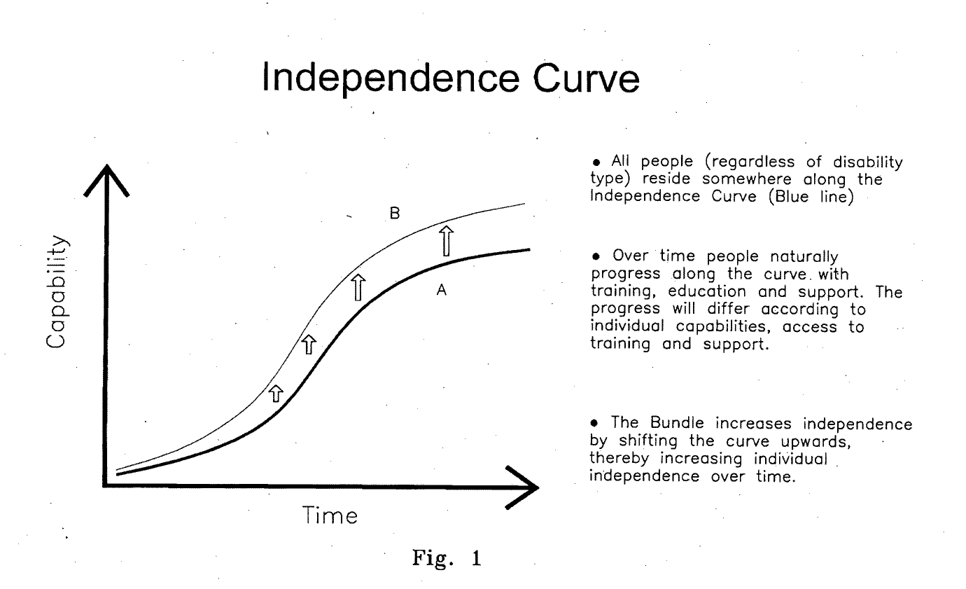

With reference to FIG. 1, there is illustrated a capability versus time graph known as the “independence curve”. Curve A is the standard curve along which all people regardless of disability type will reside. Over time people naturally progress along the curve with training, education and support. The progress will differ according to individual capabilities, access to training, education and support. The intention of embodiments of the present application is to increase independence by provision of a mobility aid system as will be discussed and described below whereby a disabled person utilising the system will progress over time more in accordance with Curve B rather than Curve A. That is the system is intended to increase independence for a given investment of time by shifting the curve upwards and thereby increasing individual independence to a greater extent over time than would otherwise be the case and in specific embodiments increasing capability to an absolute level that may not otherwise be reached by that person.

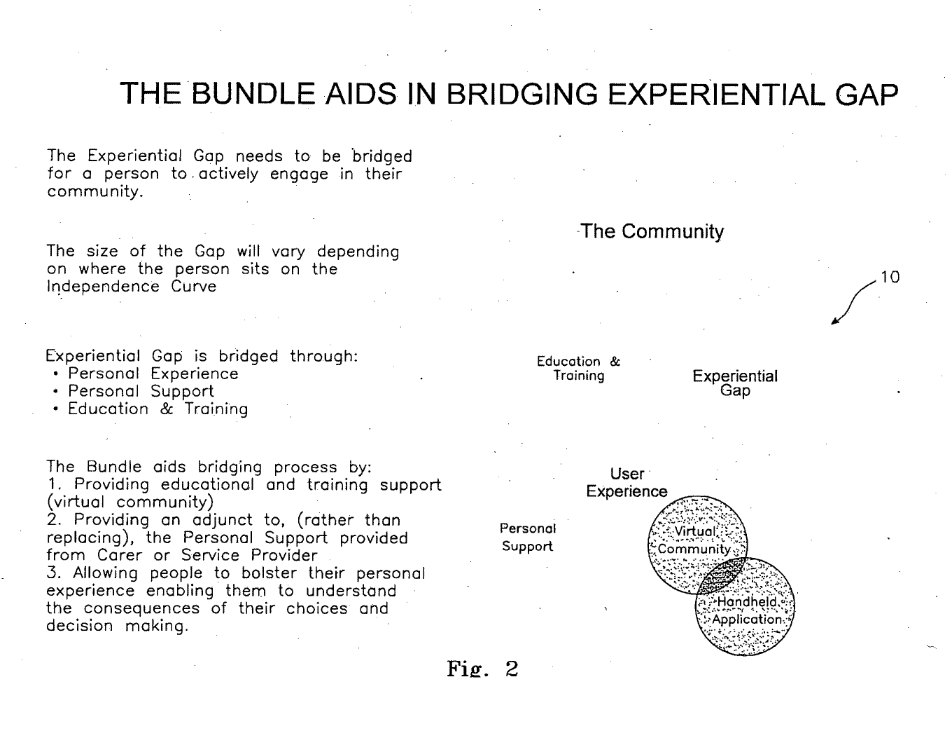

With reference to FIG. 2, components of the mobility aid system 10 and their interaction are illustrated in graphical form. Broadly speaking there is an “experiential gap” which any given disabled person must bridge if they are to be able to navigate about their community. In the present instance in addition to personal support and education and training the mobility aid system 10 includes a virtual community 11 and a handheld application 12 which, in use, it is intended will on the one hand allow a user to progress according to Independence Curve B (refer to FIG. 1) rather than Independence Curve A and more particularly to assist that person to actually navigate in a useful and functional way in their broader community.

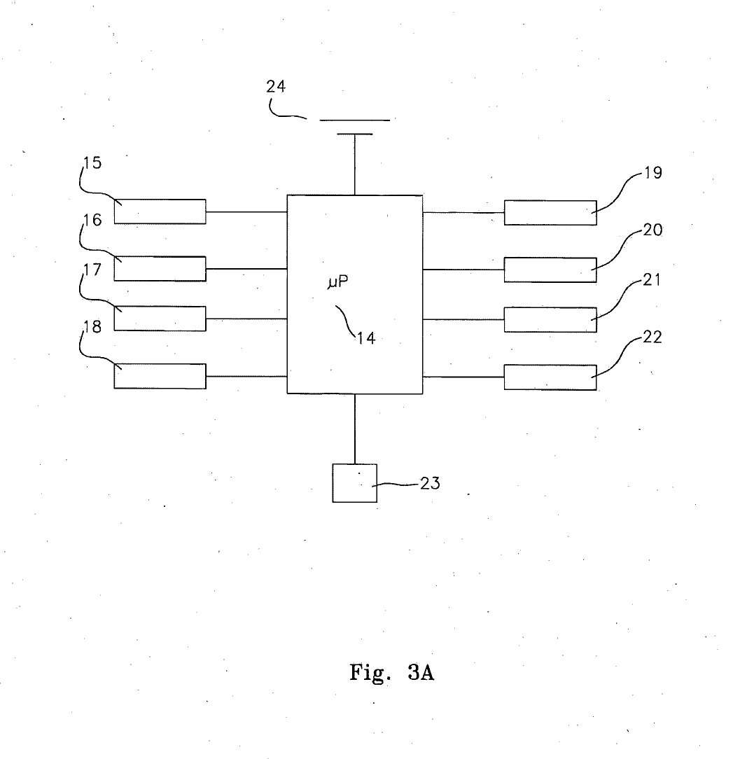

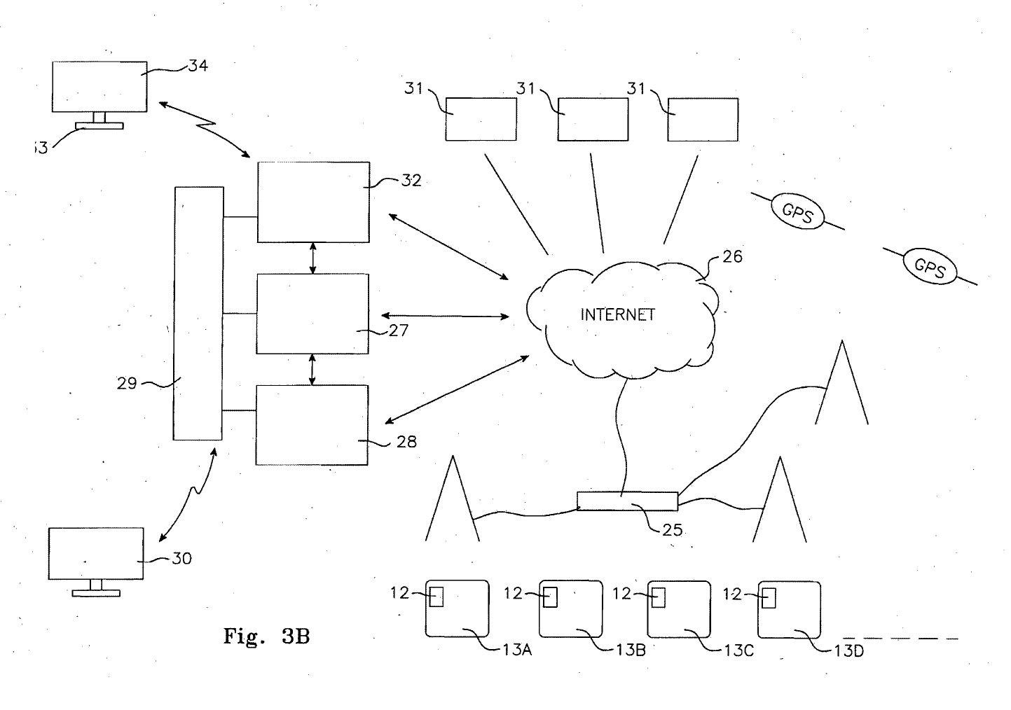

With reference to FIG. 3 the handheld application 12 will typically be implemented in a handheld smart device 13 having the components illustrated therein including microprocessor 14.

The microprocessor 14 is in communication with display 15; non volatile 16; volatile memory 17; keyboard 18; speaker 19; microphone 20; and GPS locator 21. The microprocessor 14 will also orchestrate mobile telephone communications module 22.

In this instance, handheld smart device 13 includes a SIM 23 and battery 24.

In one form, a special purpose device having the components illustrated in FIG. 3A or equivalent functionality can be built. In the alternative, the commercially available programmable handheld smart device may be programmed to incorporate the functionality to be described below.

With reference to FIG. 3B, the handheld device 13A, 13B, 13C, 13D . . . is in communication typically via the mobile telephone system 25, internet 26 with web server 27 and application server 28. The web server 27 and application server 28 are in communication with a database 29. The GPS capability of the handheld device 13 allows their location to be tracked and monitored on monitoring station 30 which is in communication with the web server 27 and application server 28 via database 29. The application server 28 can download applications to the handheld smart devices 13A, B, C . . . . In addition, third party database communicated via internet 26 with web server 27 and application server 28 thereby to provide third party application functionality to the handheld smart devices 13A, B, C . . . .

In addition, a virtual community server 32 is in communication with web server 27 and application server 28 and database 29 thereby to share data elements for the purposes of synchronising data presentation to the handheld smart devices 13 with data presented to a Virtual Community output device 33. Typically the Virtual Community output device 33 will comprise a processor and a display 34 which can present a Virtual Community animation and related functionality to a User preparatory to the User utilising the handheld smart device 13 programmed with a handheld application 12.

The functionality of the Virtual Community output device 33 and the functionality of the handheld smart device 13 will be described in more detail in subsequent embodiments.

### Second Embodiment

Many people with disabilities are unable to access basic services such as transportation or shopping without significant assistance. The Handheld Device of the Second Embodiment encompasses a customised application which resides on a small tablet style mobile phone type device—such as the Dell Streak. The device may run on the Android Operating System. The mobile device application at its most basic level will provide for a digitalised version of various memory and match to sample style aids that are currently used to train people with disabilities to accomplish various tasks such as using public transport, shopping, banking, etc. However, the functionality of the application will allow the device to act as a virtual support worker, prompting the user to successfully achieve certain tasks. The development and use of this style of device when linked with a Virtual Community—will provide a level of generalisation for people with disabilities that is not presently available.

In one preferred embodiment the application may incorporate the following types of Modules:
Transportation
Planning
Shopping
Budgeting
Banking
Help I'm Lost Functionality
Health & Nutrition

The Virtual Community is a 3D Virtual Community in which people with disabilities can plan and practice activities encountered in everyday life, undertake experience based learning, practice and enjoy a range of real community skills in the safety of a virtual environment.

This may comprise a rich and detailed virtual simulation of a community comprising of nested environments which relate to each other and which mimic the real world. In a variety of neighbourhood environments (home, local suburb, wider suburban centres, CEO and the wider country) people will enter an environment that includes real life learning around choice, decision making and an understanding of the consequences of individual actions which arise from a lack of understanding of the unwritten rules of society and the effects that these have on the acceptance of their presence in the community and upon their relationships with other people.

The Handheld Device application of the Second Embodiment provides a vital link between the virtual and real worlds by reinforcing the learning outcomes from the Virtual Community through:
Translating the teachings from the Virtual Community into the real world, providing reinforcement of these elements as and when they are really required—as people step out into their communities.
Connecting people to their communities—by individualising the application to peoples' own individual needs, preferences and aspirations—thereby making the teaching and the device based support truly relevant to the needs of each person
Providing an iterative, self-paced learning cycle in which the inevitable real world consequences are mitigated and the positive outcomes are reinforced

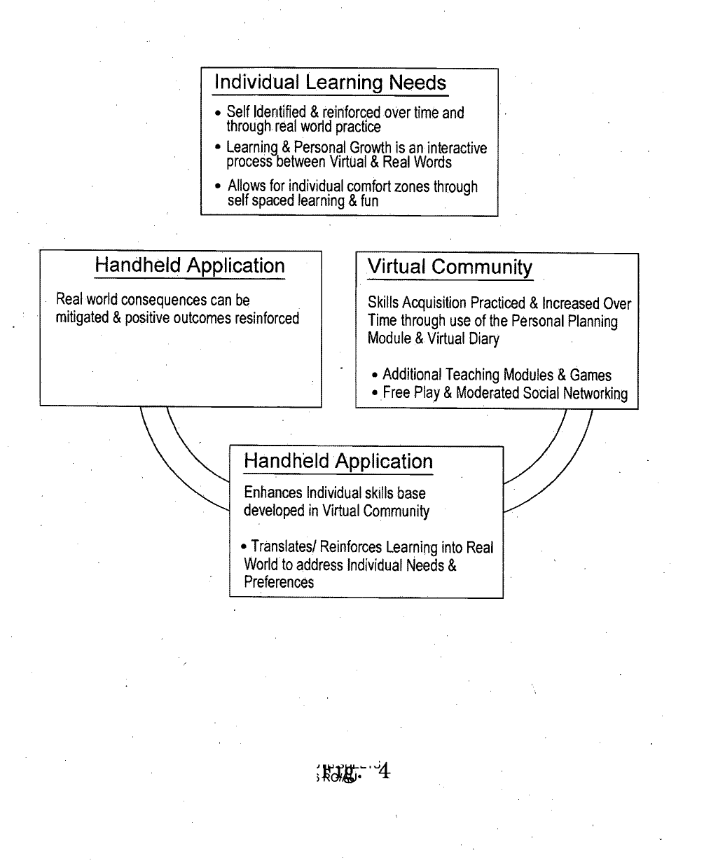

FIG. 4 illustrates diagrammatically cooperative links to be formed between the handheld application, the virtual community and an individual's learning needs when embodiments of the present invention are enlisted.

This allows users to learn from their experiences that occur in the virtual environment and to generalise these experiences into the real world—thereby cementing the learning and allowing for increased understanding of the ‘community’ and ultimately increased independence.

The various screen shots which follow in this document are for the purpose of illustrating the basic idea of the functionality required in this particular embodiment.

The handheld device according to the Second Embodiment will be programmed to operate on a device such as the Dell Streak which runs the (Google) Android operating system. It is important to note that the final choice of both the software operating system and the ultimate hardware platform may be completely different. For example, this application may be developed on the (as yet unreleased Windows Mobile 7 operating system (WinMo7) for deployment on a Hewlett Packard tablet device.

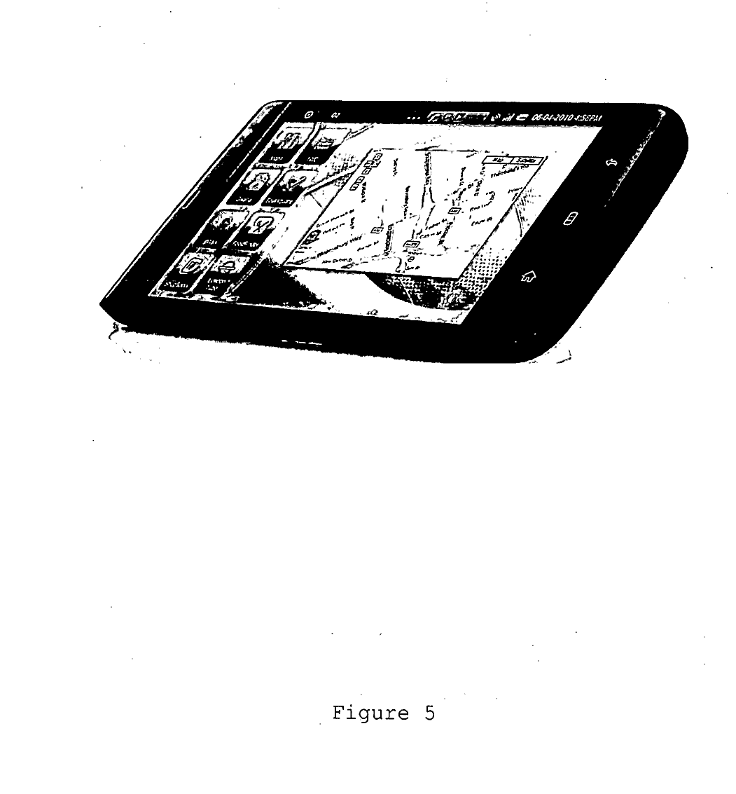

FIG. 5 is a perspective view of a handheld device in accordance with a preferred embodiment of the present invention.

This embodiment is designed to ultimately be a handheld assistant covering day-to-day activities (diary); free movement around to work, medical appointments and social locations (transport); assistance with regular activities, possibly as an assistant or as an on-line destination (eg shopping) and a Help/Emergency function.

An overview of the functionality of the handheld device in accordance with the Second Preferred Embodiment is as follows:

### Diary

This is an electronic diary for the user and is tailored to their day, their reminders and their activities. The diary content is loaded by either the user or if necessary, a support person using a remote administration system and mimics the diary the user had. The content in the diary is updated daily (as part of an overnight update process).

The diary lists what is on for the user that day; contains reminders of activities to undertake; and alerts the user as times approach for specific things (such as getting ready for work, leaving home for the bus, doing the washing today etc).

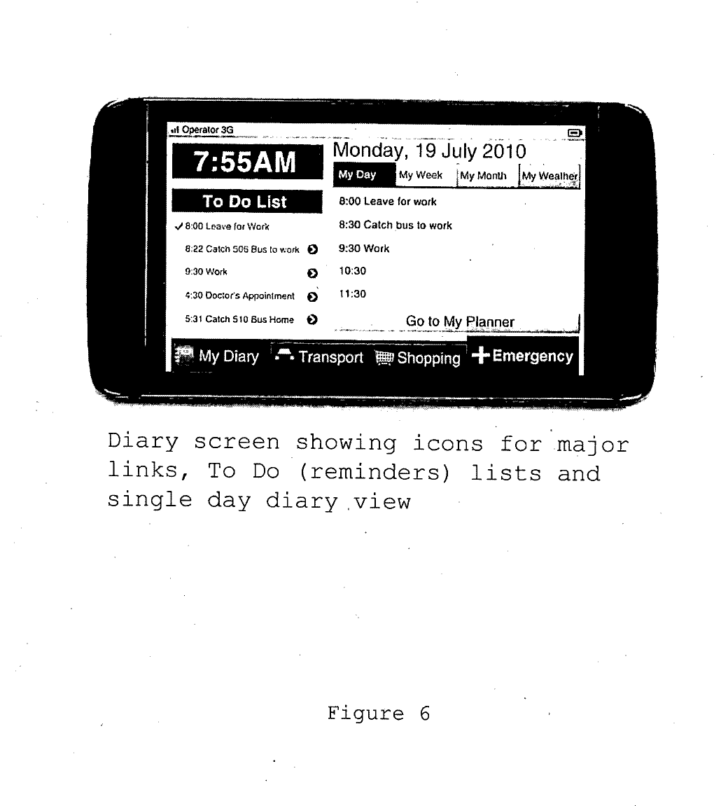

FIG. 6 illustrates the Diary Screen of the handheld device of FIG. 5.

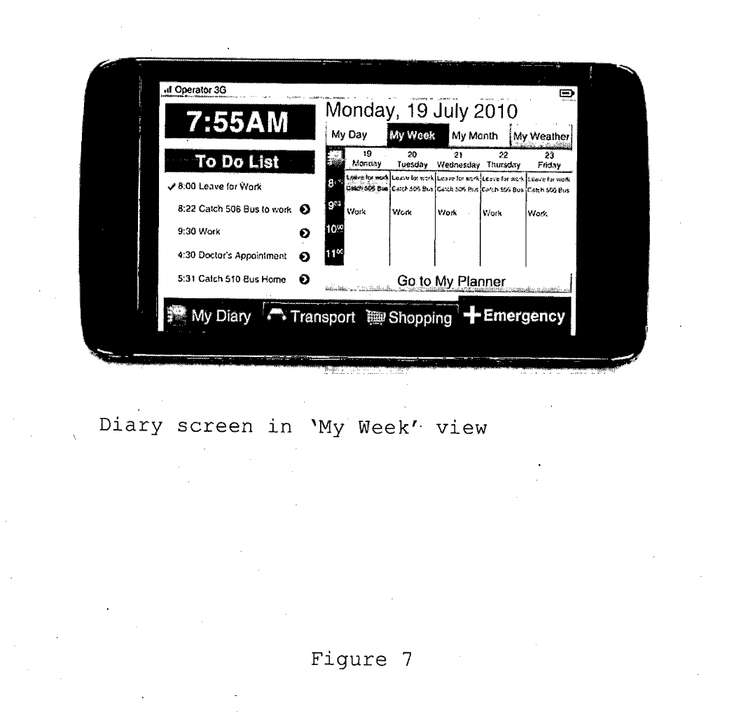

FIG. 7 illustrates the device of FIG. 5 showing the diary screen in “My Week” view.

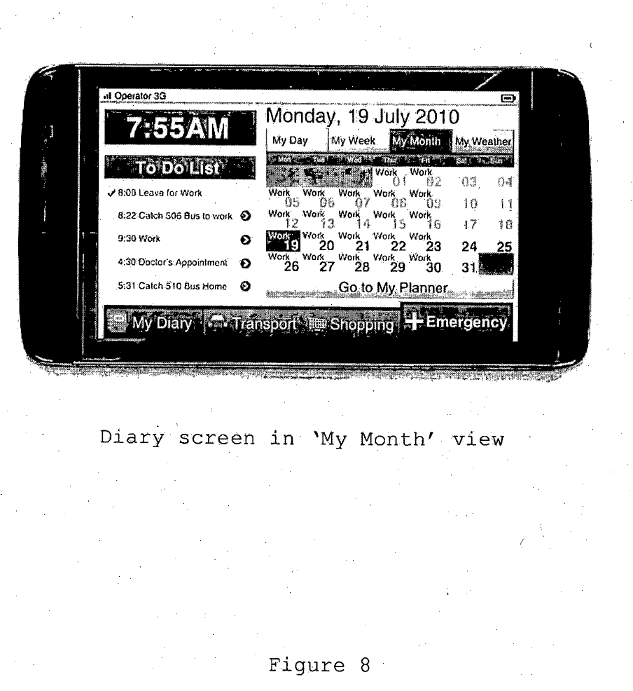

FIG. 8 illustrates the device of FIG. 5 with the diary screen in “My Month” view.

### Emergency

The Emergency functionality is a key feature for self-supporting, independent living and is useful for more than just the disabled community (potentially for older Australians also).

There is a clearly identified ‘emergency’ button on the screen of the handset. This requires double action to initiate (clicking in twice in a short period of time, eg 5 seconds) to avoid mistaken actions.

Once clicked, this immediately sends the user's GPS coordinates to Tracking HQ and also initiates a call to Tracking HQ. The user's handset is placed into loud-speaker mode so that a voice from HQ may be heard by the caller even if the unit is not held up to their ear.

At the end of the call, the system drops into a special support screen which is intended to be a help screen that can be given to any passerby and provides a series of options for the passerby to use/access to provide assistance to the user

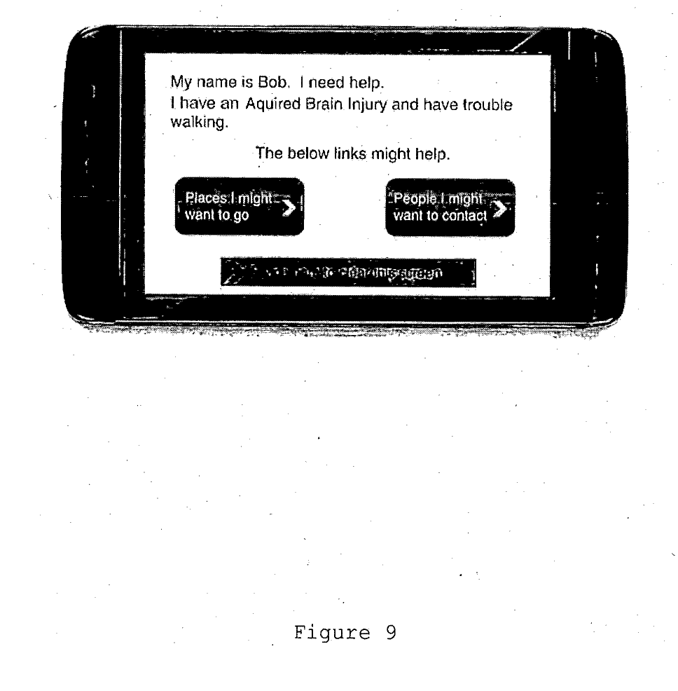

FIG. 9 is perspective view of the device of FIG. 5 in “Passerby Assistant” mode,

### Mobile Application (GPS)

The mobile application itself is the interface the user has in their hand. This is based upon a device such as the Dell Streak (mini-tablet, large phone) which has mobile network access, wifi, GPS and a large and highly responsive touch screen.

The design of the application is clear and simple and easy to access. The buttons are large and well spaced out with the emergency button highlighted. Navigation is carefully designed to be as intuitive as possible and uses both time of day/day of week and physical position to make assumptions to allow for easier navigation.

Using the Android operating system functionality, the application may send through its GPS coordinates every 15 mins (can be defined) for monitoring through Tracking HQ. The application may also run an update process nightly (can be defined) to check that the diary information is up to date.

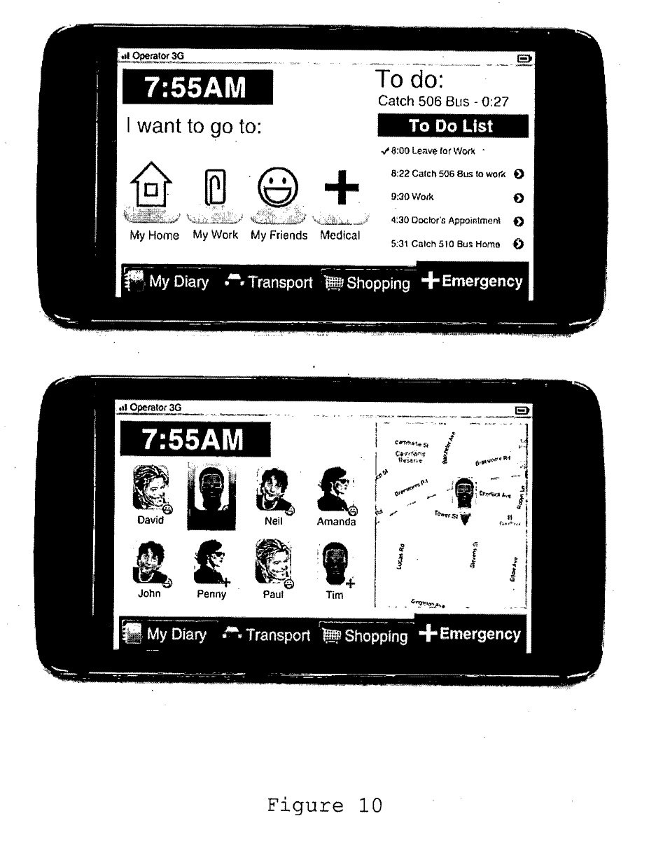

The image in FIG. 10 shows the simple icon and button design of this embodiment. Clicking on an icon brings up a display of the people (and/or places) associated with that icon. So from the ‘I want to go to’ screen, pressing on My Friends brings up a list of friends showing name, photograph and the option to select this friend, which in turn (when transport is implemented) brings up a map and a set of travel instructions on how to get from where you are to that location.

In ‘call’ mode, it brings up the name, image with the number and a ‘click to call’ button.

FIG. 10 illustrates the device of FIG. 5 in “Call” mode.

### Administration

The administration system is designed to be an online management system which allows for the specific details for each user to be added, updated, reviewed and checked. There is a record for each individual user and this contains: locations (home, work, friends, doctor—all as GPS coordinates); phone numbers (for same group, all identified with images or icons as well as names); transport routes (bus numbers and route connections); diary management (ability to create diary entries, reminders etc for user); definition of walking routes to places; shopping lists, etc)

The system is designed so that information is stored in a secure back-end server. This is accessible (via a web service) in a secure manner to allow support and care personnel to update the details for their clients. These details include filling in the diary entries; marking up the travel routes (when transport is implemented); adding contacts (friends, work and medical support staff) and keeping the details used for the emergency function up to date.

In each case, the record for each individual is available to remote staff for updates, and a specific flag may be set specifying whether an individual is allowed to amend and update their system (or which part of it) themselves, or whether the content could only be changed by authorised personnel. If the user is allowed to make changes, these are highlighted back to the responsible staff for verification.

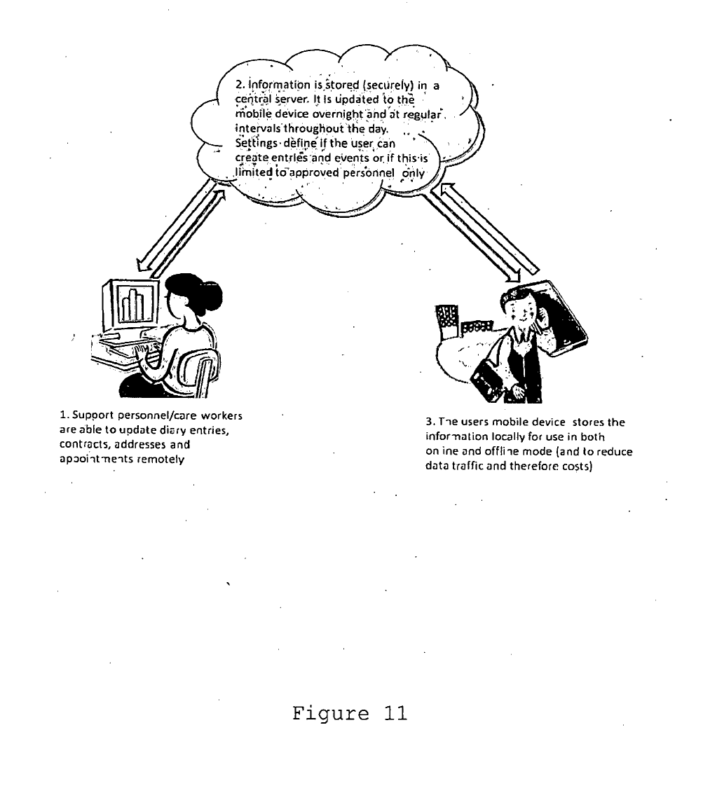

FIG. 11 illustrates interactivity links between support personnel at a first location and users armed with mobile devices according to embodiments of the present invention at another location.

### Tracking HQ

This is a centralised service in one embodiment an extension of the administration module) which shows all users on a map interface, with the ability to look for a specific users and review their current diary activities.

Any use of the emergency function on the service would generate an immediate alert to the Tracking Interface—with the user highlighted (flashing), an audio alert of an emergency situation; this will pre-empt an incoming call from the handset so that support could talk to and reassure the user.

As required, the Tracking HQ may dispatch support or emergency services to the location of the users. As long as the handset is in emergency mode, the GPS signal from the handset can be supplied every 30 seconds (otherwise, it would be on a 15 minute basis).

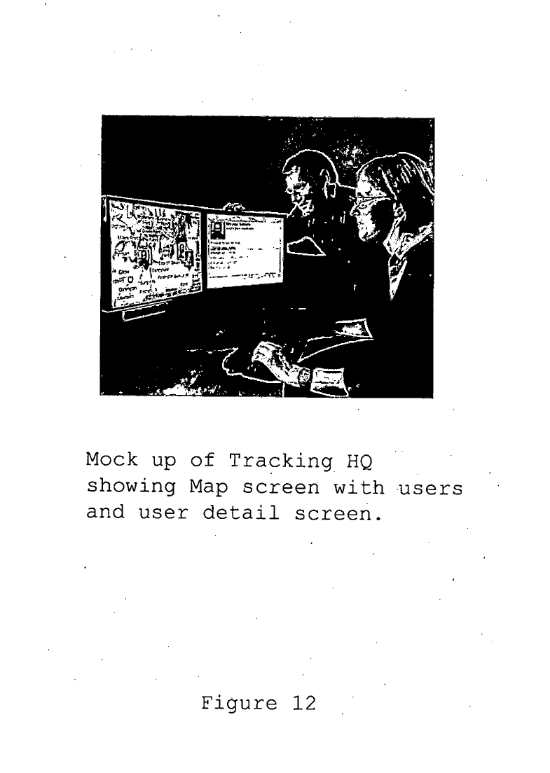

FIG. 12 illustrates the monitoring and tracking screen useable by support workers.

Tracking HQ is designed as a 24×7 monitoring centre. Tracking HQ may be the main site for administration functions including the updating of diaries, contact details, personal information etc for users of the system; as well as the central monitoring site. While the monitoring functions may be outsourced to another agency (eg SES), as the Virtual Community project expands, 24 hours monitoring may be required and Tracking HQ may be an ideal centralised agency for moderation and review of user-to-user (peer) conversations as the service moves to multi-player interaction.

Note: Tracking HQ would be set up as the first contact in the users devices for both SMS and calls through the mobile application. In this way, text messages as well as phone calls could be handled by Tracking HQ.

The handheld provides as much functionality as possible in off-line mode (eg, stored maps, numbers, tasks and to-do lists) to remain as useful as possible, regardless of the location or circumstances of the user and handset. It also allows for the addition of other modules and functionality which can be delivered as over the air updates to the handset.

### Home Screen

The Home Screen is the base from which any of the various Modules within the application are launched. The screen includes a network/battery indicator, the current time (displayed in an easy to read large digital format) and the current Day and Date. In addition the Home Screen may contain buttons to the 4 most used functions in the system—My Diary, My Transport, My Shopping and Help/Lost.

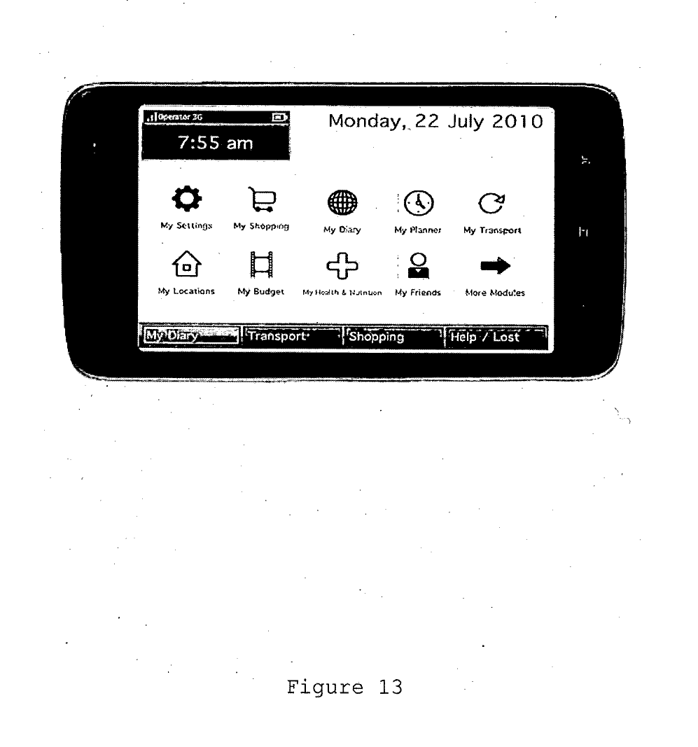

FIG. 13 illustrates the Home Screen of the device of FIG. 5.

At the bottom of the screen are to be 4 buttons that allow the User to jump to various functions within the system—My Diary/My Transport/My Shopping and a Help/Lost Function. (These buttons are to remain consistent on every page in the application.

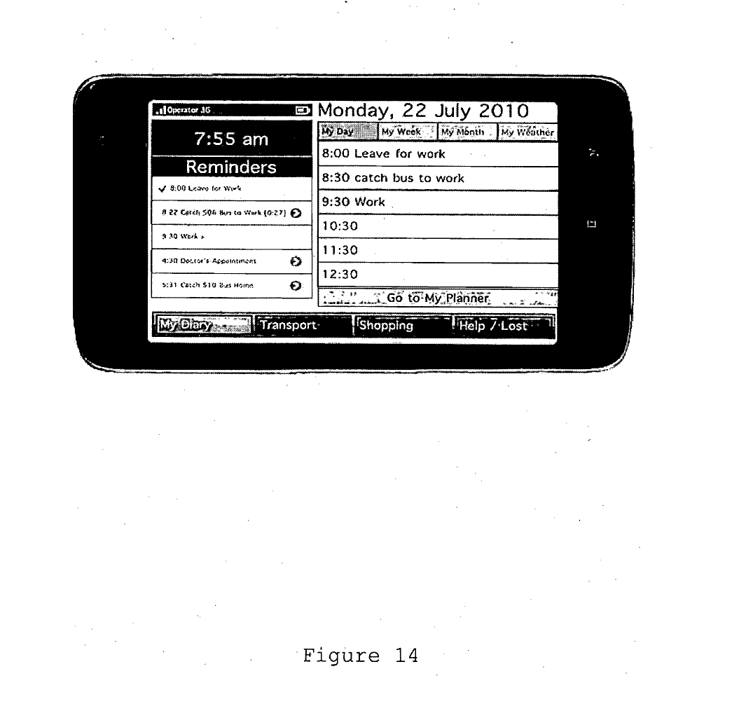

This screen may be laid out as shown in FIG. 14.

FIG. 14 illustrates a Transport Module Screen of the device of FIG. 5.

### Transport Module

The Transport Module enables a User to navigate easily from one predetermined destination to another (such as My Home to My Work) using public transport via use of the internal system GPS receiver with the various positions overlayed on a map (such as Google Maps). The entire Module is intended to be simple to navigate and wherever possible based upon icon navigation. The Look and Feel of the screens within the module can be very similar to GPS style device navigation.

The Transport Module must interface with timetable information provided by transit authorities (http://www.131500.com.au/transportdata/provides a dedicated data exchange program for these sorts of developments). The timetable information must reside on the device itself thereby limiting the need to have a live data connection in order to view/lookup timetable information.

### Location Definition

Locations are set up by the User either manually entering in the GPS Co-ordinates or by selecting the current co-ordinates when at a location (functionality similar to used in GPS MapCard2). Also the user is able to select either an icon or take a photo of the location and use that as the icon in the Selection Screen.

### Transport Screen—Select My Destination

The first user screen selected when entering the transport Module (once set up is complete) will be a My Destination Screen. This screen allows the user to select the Destination by icon (or photo if set up). At the top of the screen the current time is displayed. On the top right hand side of the screen, reminders display with a countdown timer. The screen also displays a current map with the current position overlaid on the screen.

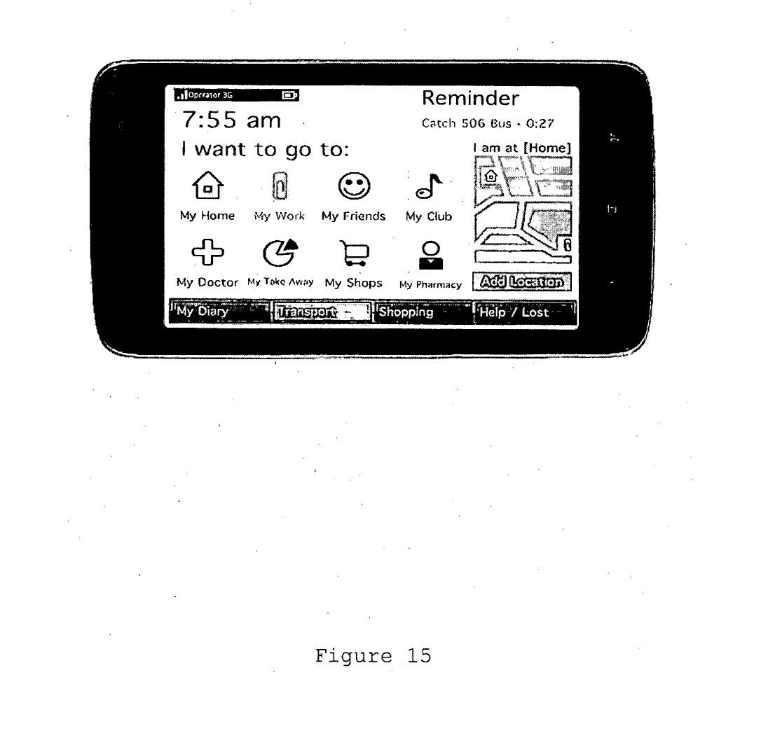

FIG. 15 illustrates the Prompt Screen for the device of FIG. 5 when in Transport mode.

Once the destination is selected the Screen defaults to an interim screen which gives basic instructions to the user about how to get to their public transport stop (train or bus).

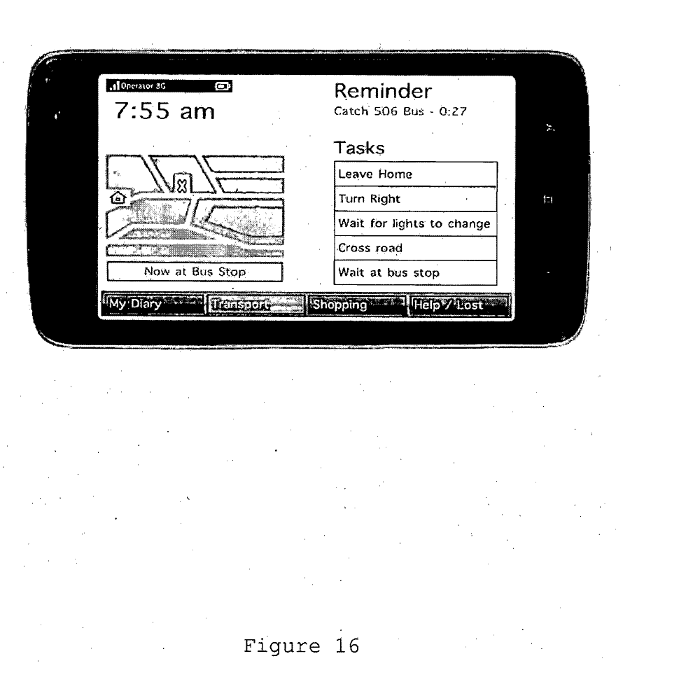

FIG. 16 is a further Prompt Screen for the device of FIG. 5 when in Transport Mode.

The Walk to Bus Stop Screen is a simple static map overlaid with the User's to and from destinations. The Time and Reminders are still displayed on the screen. On the Right hand side is a list of simple memory aids designed to prompt the user about how to get to the Bus Stop. There may be a facility for these prompts to be spoken. At the bottom of the screen is a button that the User presses when they have arrived at the Bus Stop. When complete (once Now at Bus Stop Button is pressed—the screen changes to the Transport Bus Stop Wait Screen.

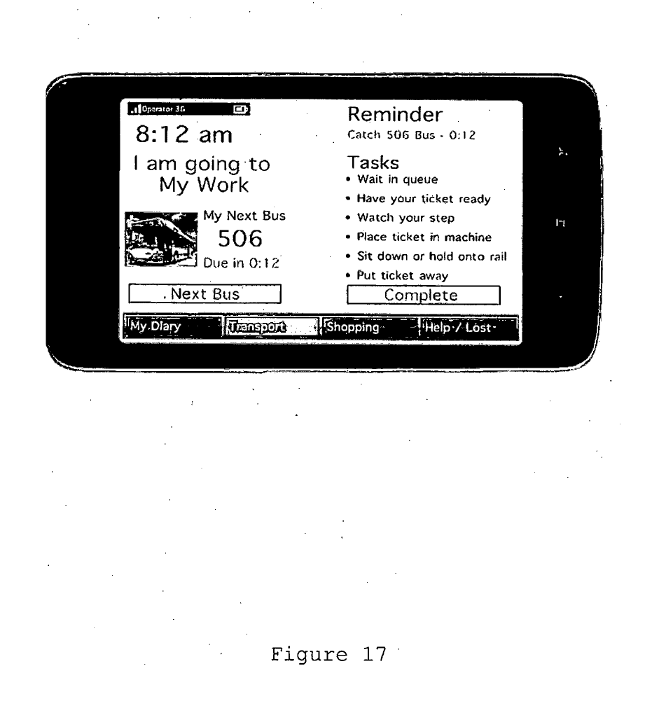

FIG. 17 is a further Prompt Screen for the device of FIG. 5 when in Transport Mode.

This Screen has the following functionality:
1. Displays the Journey Type (I am going to My Work)—based upon destination selected
2. Looks up the User predefined Bus Timetable and displays the next Bus going to the destination (by Route Number and Time)
3. Displays an image of the actual Bus (Taken from the Planner set up screen)
4. Displays a countdown timer of when the next bus is due
5. Displays a list of Tasks (Memory Prompts) that prompts the user about how to get on the bus
6. If the User misses the bus then a button allows the user to look up the next bus at that location
7. Once the User has successfully caught the bus then a button allows transition to the My Journey Screen

Some functionality is displayed in TripView Sydney application available through the AppStore

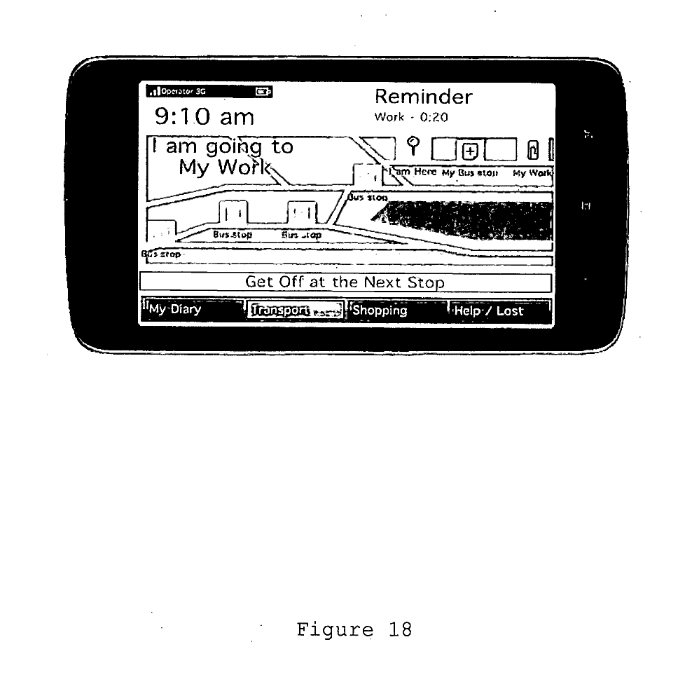

FIG. 18 is a further Prompt Screen for the device of FIG. 5 when in Transport Mode.

The My Journey Screen overlays the current user position on a map which also displays bus stop locations. When the user approaches their destination bus stop a prompt is displayed (and spoken) informing the User to get off at the next stop.

Similar functionality is displayed in NextStopGPS application available through AppStore

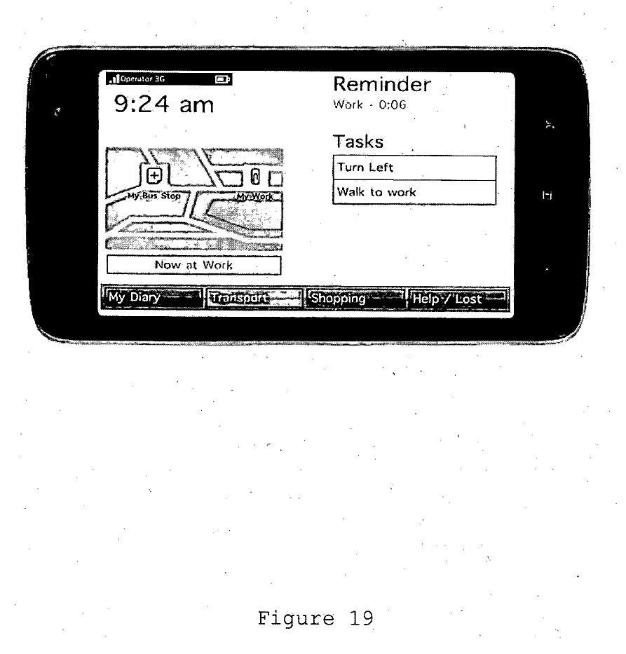

FIG. 19 is a further Prompt screen for the device of FIG. 5 when in Transport Mode.

Once the User has successfully alighted at the correct stop the Walk to Destination Screen is displayed. This is similar to the Walk to Bus Stop Screen and displays a simple static map overlaid with the User's to and from destinations. The Time and Reminders will still be displayed on the screen. On the Right hand side will be a list of simple memory aids designed to prompt the user about how to get to the Destination. There should be a facility for these prompts to be spoken. At the bottom of the screen should be a button that the User presses when they have arrived at the Destination. When complete (once Now at Destination Button is pressed)—the screen changes back to the My Diary Screen.

### Environmental Specification

### User Platform

In this embodiment, the application is based upon a simple to use icon based interface. Although the Dell Streak has been targeted, the application will function on any tablet style device which meets the following specifications.

The hardware platform includes the following:
1. min 1 GHz Processor
2.UMTS/HSDPA (850, 1900, 2100 MHz)
3. GSM/EDGE (850, 900, 1800, 1900 MHz)
4. Wi-Fi (802.11a/b/g/n)
5. GPS Receiver
6. Integrated Camera (>2 megapixels)
7. Touchscreen—minimum size—5.0 inches

### Operating System

The application in this instance is developed to run on the Android operating system.

Integration of Handheld Module into a Web-Based Support Infrastructure

The second embodiment referred to above describes primarily a preferred version of the handheld device. The functionality of that device will now be described further in conjunction with a web-based support infrastructure whereby the end use of the handheld device is monitored and supported by a monitoring station located at a remote location.

### Glossary

| Term | Definition |
|---|---|
| Admin | Server end interface for Carers to manage User |
| Module | data, route planning, Contacts, Calendar data. |
| Android | Google's handheld Operating System used on the |
| | target device |
| App | Installable mobile software; runs on the Android OS |
| Calendar | Input and Storage system for events and Tasks. It |
| | is readable and writeable via a web interface. |
| Carer | Person responsible for organising and monitoring the |
| | activities of individual users via the Admin Module. |
| CAMS | Central Administration Monitoring System |
| CCA | Mobility Aid System. Refers particularly to the |
| | virtual world designed to train disabled people. |
| CCAH | The handheld system for the broader CCA System. |
| CCAH | A custom web-based application accessible by |
| Server | external client applications via the Internet. |
| Contact | Any place or person that may be ‘contacted’ by a |
| | User. Also used as a start/end point in a planned |
| | journey if it has an LOI |
| Database | Collection of all the information monitored by |
| | this system. |
| Event | An action to be taken by a User. An Event is |
| | stored in the Calendar. |
| HQ | Headquarters. Provides a call centre for |
| | Emergency assistance to Users. |
| Journey | A route from one LOI to another LOI, or from a |
| | GPS location to an LOI. A Journey is a set of |
| | segments that are either Walking or Transit. |
| LOI | Location of Interest. An Addressable location |
| | that can be used as a start/end point in a planned |
| | Journey. An LOI belongs to a Contact. A Contact |
| | may have several LOIs |
| POI | Point of Interest. This is a single stored GPS |
| | location that has relevance within a planned |
| | route, but does not include the start or end |
| | points as these are LOIs. |
| Super | Administrator of the Admin Module. Can create new |
| Admin | Carers and CAMS Users. |
| User | Disabled person equipped with the handheld CCAH |
| | application. |
| User | The existing CCA database. This holds user |
| Database | profile information. |
| To-do | Time related event with option to add description |
| Done | Ability for Admin to add a To-do that requires |
| feature | “ticking off” and ability for User to “tick off” |
| | on device. |

### Introduction

### Purpose

This follows a detailed description of the CCA Handheld application system of the Second Embodiment. It explains the purpose and features of the system, the interfaces of the system, what the system will do, the constraints under which it must operate and how the system will react to external stimuli.

### Project Scope

This software system consists of a Mobile Application and Application Server, loosely integrated into the broader Mobility Aid System. This system is designed to assist disabled people in their everyday lives by providing “in-the-pocket” tools to instruct them in performing tasks within general society. Through simple UI design and tightly managed task planning the system provides disabled users with mobile assistance on a high tech device while remaining easy to understand and use.

More specifically, this system is designed to present managed task lists, a calendar of events, trip planning and commonly used contacts to the Users. The handheld application will reinforce the learning outcomes generated through the Virtual World component (to be described further on in this specification).

This embodiment comprises:
Android application for preload on a Dell Streak device
a custom Application Server exposing Web Services
3rd party route planning Server
a relational database
An online Calendar/Contacts system
administration interfaces (including CAMS).

### System Environment

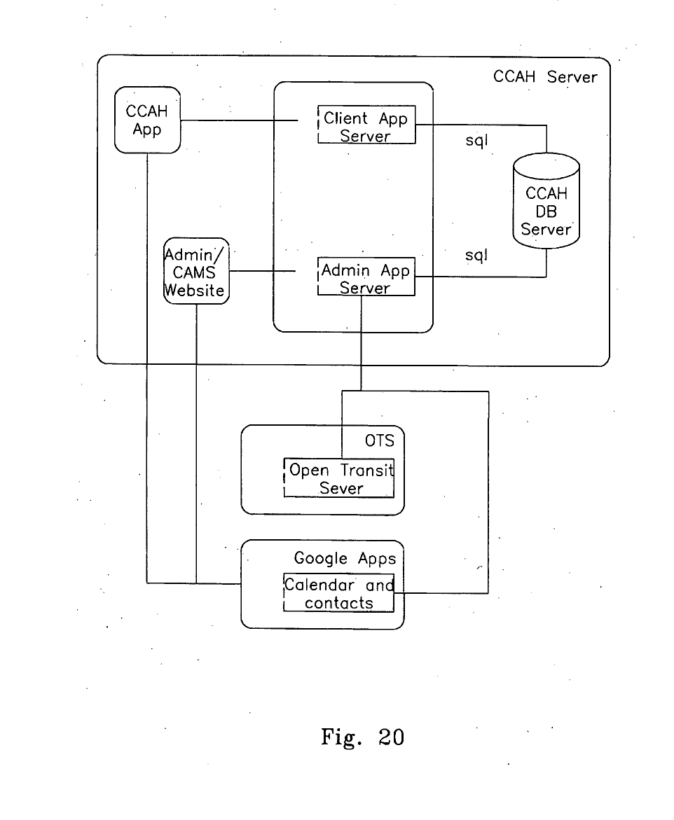

FIG. 20 is a block diagram of the main components of the mobility aid system in accordance with a further embodiment of the invention.

Key components of the System are:

### CCAH Server

This server can be logically divided into the Client App Server, which handles requests and responses for the CCAH App, and also the Admin App Server which handles requests and responses for the Admin Website.

It is generally responsible for:
providing a Web Service for all requests for data from the CCAH Mobile App and the Admin/CAMS web interfaces.
It makes all required database requests
makes requests to the Open Transit Server for transport route data when required
Communicates with the external Google Calendar and Contacts system.
Renders server scripted pages for the Admin/CAMS web interfaces.

### CCAH Database

Primarily holds User profile data and authentication. Also holds any references to Google Calendar and Contacts, as well as stored Journey data.

### Admin & CAMS Website

Each User has an assigned Carer who sets up User profiles, navigation routes, Contacts, Calendar Events and usage settings and does regular maintenance on user-related data. This is done through the Admin Website and Web App to the CCAH Server.

Additionally, the Admin Website has a central monitoring system (CAMS) to allow CCA HQ staff to view the whereabouts and details of all Users, and make direct phone calls to Users.

### CCAH App

CCAH App is a mobile Android Application. It provides User Interface to the User's Calendar containing Events and Notes, and provides reminders when they fall due. Additionally it shows categorized Contacts and allows interaction with these Contacts (call them, navigate to them etc). Certain users may also edit Contacts and make edits to their Calendar via the CCAH App.

The App synchronises the mobile Calendar and Contacts data with the online Google System. User settings and GPS coordinates are synchronised with the CCAH Server.

### OTS (Open Transit Server)

When a User wants to go to a LOI, the App will need to request a point-to-point route.

Commonly used routes are initially generated by Carers and stored in the Database for each User. These routes are generated through the use of the Open Transit Server.

When an adhoc (dynamically generated) route is required (i.e. from an immediate GPS coordinate to a LOI), the CCAH Server will need to request a route to be generated instantaneously by Open Transit Server.

### Google Apps

Open third-party hosted system for management of User's Calendar and Contacts. It provides a Content Management System with a set of Server APIs that will be used by the CCAH Server.

### Use Cases

### Actors

| Actor | Description of role |
|---|---|
| User | A disabled person with an Android device. |
| | Accesses the CCAH Server and Calendar through |
| | the handheld App. The User accesses routing and |
| | personalized information from the CCAH Server |
| | through the handheld App via the Internet. |
| Carer | A Carer who accesses the CCAH platform. Has |
| | access to their allocated Users and their Users' |
| | respective profile information (as assigned by |
| | the Super Admin). The Carer accesses the |
| | Calendar and other functions through the Admin |
| | Module and Internet. They may also physically |
| | access the handheld device of their User for |
| | configuration purposes? |
| CAMS User | has access to all collective Carer capability |
| | plus access to certain functionality that |
| | standard Carers do not. |
| Super | has all CAMS capability plus the ability to |
| Admin | create, edit and delete CAMS Users and Carers. |

### User/App

I. Initialize Google Settings on Handset

Google Account settings must be set by a Carer on behalf of the User prior to giving the handheld device to the User.
1. Start Handset
2. Go to Settings→Accounts and Sync→Add Account
3. Choose ‘Google’
4. Follow Wizard

II. Make Emergency Call to HQ

The Emergency call feature is a major part of the App and is accessible from most screens.
1. Press Emergency Button
2. Dialog will Pop Up to confirm if User really wants to make an Emergency Call
3. Press ‘Yes’
4. Call is made to Emergency HQ.
5. During the call, a screen is shown with information for any nearby helpful person which will allow them to assist.

III. View Calendar

The Calendar is a feature that is available from the Home Screen or from the Navigation bar on most screens.
1. Press ‘Calendar’ button
2. Calendar appears in default Month View with today's TO-DO list presented next to it.
3. Choose “month” or “week” tabs to change View
4. Press left or right buttons to change month/week
5. Press on a specific Day to change the To-Do list to that day.

IV. View Event Details

Each Event for a chosen day will appear chronologically in the To-Do list. Some Events are “All Day” Events meaning they don't appear chronologically as they can be relevant at any time of the day “e.g. Public Holiday Today”. “All Day” Events will stay pinned to the top of the To-Do List.

To view the details of an Event a user simply presses an Event and it will expand in accordion fashion to reveal the notes relating to that Event.

Viewing Event details can be done from any screen where the To-Do list is present.

V. Complete Event/To-Do

Each Event in the To-Do list will have a checkbox to indicate whether it has been completed or not. To mark an event as complete the User must check the checkbox. Certain Events that MUST be completed will be pinned to the top of the To-Do list but only when they become due (like All Day Events are) until they are checked. Events that do not require a “mark as complete” action or have been marked as complete by the user will simply remain on the list at the relevant time but the reminder prompt will no longer display.

Marking an Event as complete can be done from any screen where the To-Do list is present.

VI. Add Event

If a User has Edit privileges they may Add and Edit Events from within the App.
1. Go to Calendar Feature
2. Select Date for Event (defaults to TODAY)
3. Press “Add Event”
4. User must follow a Wizard of three successive screens to enter the details of the new Event.
5. Save Event
6. The Event will then appear in the App's calendar on the specified day at the specified time. It will appear in the Admin Interface Calendar once a synch has been completed by the App.

VII. Execute Event-Related Journey

Some Events will have an associated Journey for the User to take, e.g. “Go To Doctor”. This is represented by a Journey Icon next to the Event in the To-Do list.
1. View To-Do list
2. Select an Event—If the Event has an associated Journey it will show a “Journey” icon to the User.
3. Clicking the icon will take the User to the Journey Planner wizard.
4. User will select the From LOI
5. To LOI will be pre-selected
6. See ‘Take Journey’

VIII. Take Journey

When a User wants to go to a specific LOI they can use the Travel feature to plan the Journey and follow steps to get there.
1. Select Travel from Home screen or Navigation menu
2. User will be presented with a wizard to set up the Journey
3. Choose the From LOI from a list of LOIs including their current location as determined by GPS
4. Choose the To LOI from a list of LOIs
5. User sees the Route screen showing
   a) a map with the route overlayed
   b) a complete list of textual instructions for the entire route.
6. The Route segments (Walking or Transit) are shown in different colours. A User can press a specific segment and the map will zoom onto that segment. The textual instructions will then show only the instructions for that segment.
7. User can follow the instructions by clicking on each one and viewing the associated map segment.

IX. Call a Contact
1. Select Contacts from Home screen or Navigation menu
2. User is presented with an icon list of their Contacts by category, with the default being ALL.
3. User selects a category to filter the Contacts
4. User presses the icon of the desired Contact
5. User is presented with a screen showing all details of that Contact and all methods for contacting that Contact
6. User selects desired method (e.g. call mobile) which will trigger the native Android activity for performing a phone call.
7. Once User has hung up they will return to the contact screen of the Contact they have just called.

X. SMS a Contact
1. Select Contacts from Home screen or Navigation menu
2. User is presented with an icon list of their Contacts by category, with the default being ALL.
3. User selects a category to filter the Contacts
4. User presses the icon of the desired Contact
5. User is presented with a screen showing all details of that Contact and all methods for contacting that Contact
6. User selects desired method (e.g. Text) which will trigger the native Android activity for performing Text Messaging.
7. Once User has sent the SMS they will return to the contact screen of the Contact they have just called

XI. Add Contact

If a User has Edit privileges they may Add and Edit Contacts from within the App.
1. Select Contacts from Home screen or Navigation menu
2. Press “Add”
3. User must follow a Wizard of three successive screens to enter the details of the new Contact.
4. Save Contact

XII. Add a Photo to Contact

This use case is part of the Add Contact or Edit Contact use case during the use of the Add Contact wizard.
1. User select to ‘Take a Photo’ or ‘Choose photo from Library’

XIII. Send GPS Ping

The CCAH App will automatically send the most current available GPS coordinate to the server on a period basis (as determined by the carer in the admin module).

XIV. Update App

XV. Receive and Install Settings Updates

The Response from Send GPS Ping requests will contain any updates to settings as input by the Carer at the Admin Module. These new settings will be automatically installed into the App.

### Career/Admin

I. Login

A carer can access the Admin Module through a secure website. They must login using their Username and Password that is provided by a Super Administrator. These login details will be sent to the carer via email. The email will include the url for the admin module.

II. View all Assigned Users

A Carer can have one or more Users they administer. They can view all of their assigned Users in a list of icons and names.

III. Add New User

To add a new User to their list of Assigned Users, a Carer must do the following:
1. View all assigned Users
2. Click “Add New User”
3. Enter the new user's profile details into the web form
4. Save the Profile
5. Create the User's Google Account (see Use Case 4.3.4)

XV. Create Google Account
1. Click link on Admin Website to Google Gmail. This will open a new window
2. Enter account information for the new User Gmail and click “I accept. Create my Account”
3. Close Gmail window
4. The User will now have a Google Calendar and Google Contacts that can be accessed from within the Admin Website or the Google Website.

V. De-Activate a User

If Admin wants to de-activate a User, they will need to be in the User's Profile screen.
1. Click on View Profile
2. Tick the radio button to De-activate User

VI. View a User
1. View all assigned Users (see Use Case 4.3.2)
2. Click on a User
3. This will make that User the selected user. That User's profile will be shown in a part of the screen at all times that they are the selected User.

VII. Edit User Profile

Once the Carer has selected a User they can click the Edit User Profile button. This will take them to a form showing all fields of their profile populated with the current values. These fields may be edited and the form saved.

VIII. View all Contacts of a User

Clicking on this will display all contacts for the User including:
Name
Address
Phone numbers
Image of Contact
What Group” they belong to (friends, family, medical etc)
If they are a “Favourite” contact
If the User is barred from calling any of the numbers attached to this contact.

IX. Add a New Contact for a User
1. Clicking on “Add Contact” will present the Carer with a set of fields to complete.
2. Each Address entered for a Contact will need to become an LOI. In order to do so, the Carer must first verify that the system has correctly geocoded the address. They will click ‘view on map’ to see the address point on a map popup, then click “correct” to verify it is correct, or “incorrect” if location is wrong.
3. Click “Save”.

X. Edit a Contact

The Carer will have the option to edit each field of that contact and Save. If an address is edited this will affect any Journeys that involve that address. Those Journeys will be deleted and need to be recreated with the new address.

XI. Delete a Contact

When the Carer is in the “View Contacts” section, the Carer will have the option to delete that contact and all information relating to it. Before the contact is deleted the Carer will get a pop up message asking to confirm they want to delete. If “yes” is selected, the contact will be deleted and the carer will be taken back to the “View User” screen.

If the Carer clicks “No”, they will be taken back to the View Contacts screen.

Deleting a contact will also delete any Journeys associated with that Contact's LOI(s).

XII. View Calendar of User
1. Click the link to the Users Calendar.
2. A custom UI representation of the Users Google Calendar will be shown.

XIII. Add a New Event

Assuming Carer is at the Google Calendar interface.
1. Assuming Carer is at the Calendar interface.
2. Carer clicks on a day. This will present a New Event input window.
3. Carer enters Event Name and details including start time, end time, event details, reminders and repetitions.
4. Click Save

XIV. Edit an Event

Assuming Carer is at the Calendar interface.
1. Carer clicks on an existing event. This will present an Event details screen.
2. Click Edit Event Details. This opens a screen where the Carer can edit a range of fields, including start time, end time, event details, reminders and repetitions.
3. Click Save

XV. Delete an Event

Assuming Carer is at the Google Calendar interface.
1. Carer clicks on an existing event. This will present an option to Delete Event.
2. Click Delete

XVI. View all Journeys of a User

This will show a list of journeys that have been pre-determined in alphabetical order, for example:
Doctor to Home
Doctor to Work
Doctor to Sarah's House

Each Journey will have a map icon next to it. If the Carer presses the icon they can view the full journey on a map.

XVII. Create a New Journey from LOX to LOI

Every Contact for the User that has an address attached to it is an LOI. If there are multiple addresses within a single Contact then that Contact will appear as multiple different LOIs.

To create a new Journey:
the Carer first Views all Journeys of a User (see Use Case 4.3.16).
click “Create new Journey”. This takes the User to the Create Journey Screen.
Select Start LOI from a list of LOIs. Click “Next”.
Select End LOT from a list of LOIs. Click “Next”
Choose the Date of Journey (this can be the date of the first known use of this journey)
Enter the Start time of Journey
Click “Generate Journey”
The generated Journey will appear in a window (hopefully embedded in the Admin Interface . . . TBC).
Carer can click “Save” or modify the inputs and generate again.
Once Saved, the Carer will be shown an overview of the Journey's Segments. From here they may Edit the Walking Segments if required (see Use Case 4.3.18)

XVIII. Edit a Journey

The Carer is presented with a list of journeys as set out at “View All Journeys of a User—4.3.16” above. As well as having the option beside these to “View journey”, there is also the option to “Edit” a journey. The Carer views a high level list of Segments for the chosen Journey. A Segment is either a Walking Segment or a Transit Segment. The Carer can select any segment (e.g. with a radio button) and choose to edit that Segment.

If the segment is a Transit Segment:
The Carer is presented with the original fields used to generate that Transit segment.
The Carer may edit the fields and then generate a new Transit segment.
The new segment is shown on a map and the Carer can “Save” or “discard”

If the segment is a Walking Segment:
The Carer is presented with a map showing the start and end points of the walking segment.
The Carer will plot the walking route point by point and can enter notations at any point.
The Carer will click “Save” and then click “Done”.
The Carer will be returned to the high level Edit Journey screen and will see that their new Walking Segment has replaced the old one,

XIX. Delete a Journey

This option can be found on the “View Journeys” screen.

Before the Journey is deleted, the Carer will get a pop up message asking to confirm they want to delete. If “yes” is selected, the journey will be deleted and the carer will be taken back to the “View User” screen. If the Carer clicks “No”, they will be taken back to the View Journeys screen.

XX. Assign a Journey to a Calendar Event

Some calendar events created by a Carer will require a reference to a pre-planned Journey. The Carer can do this by linking a Journey to the Event when creating the Event (4.3.13) or editing the Event (4.3.14).

XXI. View User-Generated Updates

XXII. View User-Generated App Activity

XXIII. View Last 6 Known GPS Co-Ordinates of User

### Cams User

X. Login

II. Select Map Region

III. Show all Users

IV. Show Subset of Users

V. Search for a User

VI. View Alert for a User

If a User's GPS location update is more than 2 hours past update time (due to no signal, server down, misplaced device or faulty device), the User will be highlighted on a map

VII. View Summary Details of a User (See Requirements Above)

VIII. View Historical Tracking of a User

This will display the user's last known GPs co-ordinates on the CAMS map.

IX. Initiate Call to a User

X. Receive a Call from a User

### Super Administrator

I. View all CAM Admins

II. View all Admins (Carers and CAMS Admins)

III. Add New Admin (Carer or CAMS Admin)

IV. Delete an Admin (Carer or CAMS Admin)

### CCAH App Software Requirements

I. Alert Users of Due Events

II. User Access Levels

III. Expose an Android Widget on the Home Screen for Quick Access to the App.

### CCAH Server Software Requirements

The CCAH Server will accomplish the following primary functionality:

I. Web Services

Provide a Web Services interface for the CCAH App and Admin Module to request data and synchronise with.

II. Database Access

Access the Database for User and Cached data. The CCAH Server will handle all database access. Most data operations will occur through stored procedures on the database server, though some direct SQL queries will take place.

III. Construct Dynamic Journeys

Construct Journey routes from LOI to LOT through use of Trip Planning Software. This can consist of walking and transmit segments.

CCAH Server will use the Web Services provides by the Open Trip Server to request adhoc. route data.

IV. Web Server Pages

Render a web interface for the Admin Module.

Render a web interface for CAMS.

V. Google Apps

Interact with Google Apps (Calendar, Contacts) through Gdata APIs.

### Admin Website Software Requirements

The Admin Website is primarily rendered as server pages by the CCAH Admin Web App

I. Login

Admin login must be authenticated against the CCAH database. The response will be either A successful login will result in a session that will timeout after 30 minutes of inactivity.

inputs:
username
password
outputs:
success/fail
userlevel

IX. View all Relevant Users

An Admin can have one or more Users they administer. They must be able to select the one they are working with at any point in time.

inputs:

### Admin Id

outputs:

### Collection of Users

### Add New User

This involves the input of a new User Profile and creation of a Google Mail Account for the User.

### Fields:

1. Name
2. Gender
3. Medical condition
4. Address
5. Image/icon of User
6. Phone/Mobile numbers
7. Google Email address
8. Google Account Password
9. Google Calendar ID
10. Frequency of GPS reporting
11. User Access Level (1 or 2)
12. Activated (true=active, false=deactivated). Deactivated User can be reactivated at a later date. A de-activated account will retain all user profile information.
13. Activated in the VC (true=active, false=not active).
14. Skill Level in VC
15. Mobile IMEI

### Access Levels

Users may have different levels of usage for the Calendar and Contacts.
Basic
Advanced (User may add calendar entries and contacts via the mobile App)

### Creating the User's Calendar

A User's Calendar is actually a Google Calendar hosted under the User's Google Account. It gets created automatically when the User's Gmail account is created. Calendar details will be saved in the CCAH Database so the calendar can be accessed by CCAH Server using Gdata APIs.

The Carer will be able to create and edit events within the User's calendar using the Admin Calendar UI. Any events created by the Carer will be a rendered in a different colour to those created by the User through the CCAH App.

III. Select a User

Carer can select a single User to work with from the collection of Users.

### Input:

### User Id

### Output

### Selected User's Profile

### Edit Profile

Carer can edit any of the profile fields and save the changes. The wireframes displayed below are indicative only.

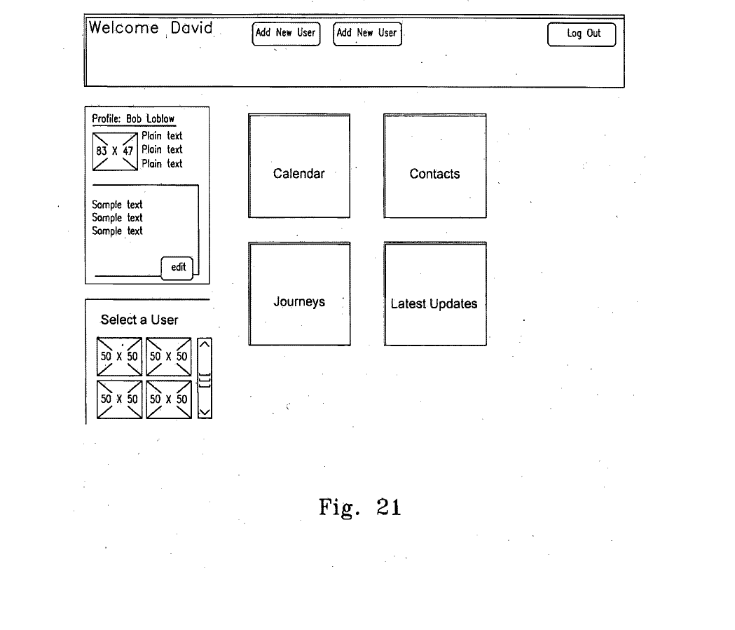

FIG. 21 illustrates an “Edit Profile” function for the system of FIG. 20.

IV. Contacts

Contacts are stored within a User's Google Account. They can be accessed visually via the Google Web Interface, or the Admin Server can request them programmatically using Gdata Contacts API and present them in the Admin Website.

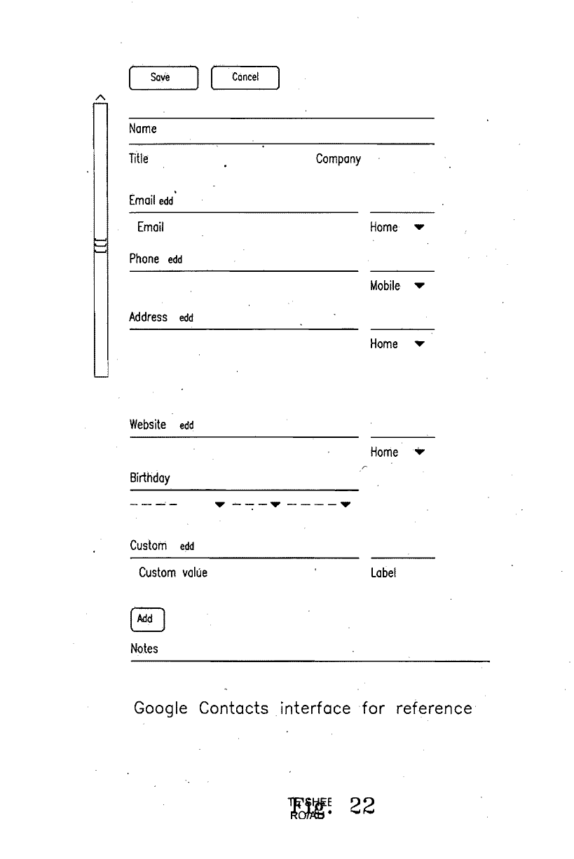

FIG. 22 illustrates a Contacts Interface for the system of FIG. 20. Contacts can be created, edited and deleted.

They can be grouped into the following groups:
Friend
Family
Doctor
ALL—default

A Carer can bar (and un-bar) calls to a contact if required.

A Contact can belong to multiple groups. They can also be tagged as Favourites.

### Fields Include:

Name
phone number (0 to many)
Address (0 to many)
Group
Favourite
Photo/icon

### LOIs

Each Contact-Address pair can become an LOI, which will be stored in the CCAH Database and used for Journeys. The Lat/Long for an LOI will be generated by geocoding the address, but there must be some human interaction to verify that the geocoding was done correctly.

If a Contact's address changes or a Contact is deleted by the Carer then any Journeys that reference an associated LOI must be deleted.

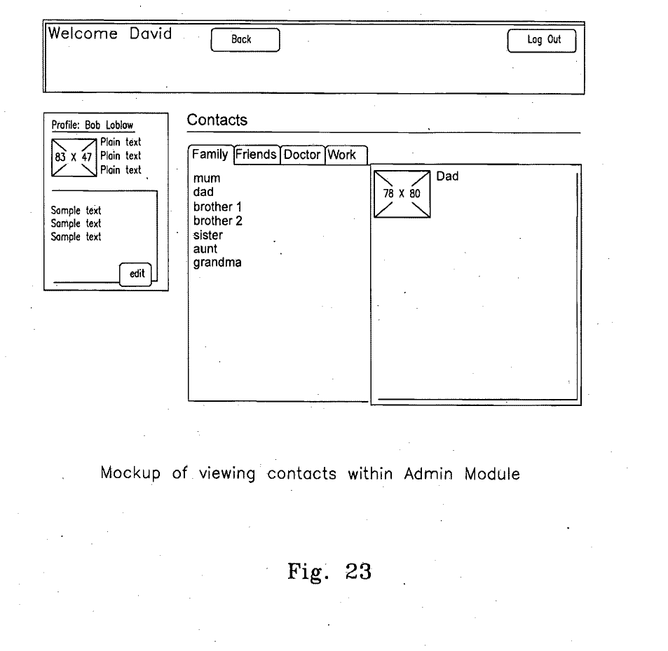

FIG. 23 illustrates the Contacts Module for the system of FIG. 20.

V. View Calendar

A visual calendar interface will be used in the Admin Website to show a Users Events and allow Admin to add/edit/delete Events. The Google Gdata Calendar API will be used to perform these tasks (http://code.google.com/apis/calendar/data/2.0/developers_guide.html)

### Calendar UI

The default Calendar view will be the current month with today highlighted. It will be generated using Jquery plugins, HTML and CSS rather than being generated by server pages (JSP). The Server, however, will fetch the existing Event data from Google Calendar to populate the Calendar UI. Potential plugins to use:
FullCalendar
http://arshaw.com/fullcalendar/
JmonthCalendar
http://www.bytecyclist.com/2009/08/09/jmonthcalendar-options-events-methods-documentation/
iCal Style Calendar
http://www.stefanoverna.com/wp-content/tutorials/ical like calendar/
Web Delicious
http://www.web-delicious.com/

### Creating and Editing Events

Clicking on a day in the calendar UI will popup an Event Creation form. Clicking on an existing event will popup the same for but with fields populated with the Events data.

Events entered into the calendar must have fields used by Google Calendar:
Event Name
Start Date
End Date
Recurrence settings
Location
Description
Reminder period
Start Time (not set for All-Day Events)
End Time (not set for All-Day Events)
   Calendar Events with a Journey Reference

In the CCAH App the User will view events in their calendar and in some cases have the ability to click a button to view a journey map and instructions, e.g. Go To Doctor. This means that some calendar events created by a Carer will require a reference to a pre-planned Journey. The Carer can do this by linking a Journey to the Event in the Admin Website.

A Custom field for an Event can be created using the <extendedProperty> element with a name-value pair for that property:

http://code.google.com/apis/calendar/data/2.0/developers_guide_protocol.html#AddittonalOps
e.g. <gd:extendedProperty name=“journeyId” value=“theId”/>

This property will be read and parsed on the client and will allow the associated Journey to be loaded and viewed.

### Completed Events

The User also has the ability to “tick off” any tasks or events in the App's Calendar as they complete them. There is no native “done” functionality in Google Calendar for marking off events so the client will append a Unicode Checbox character to the label of any completed Event. Admin will see these “ticked” events in the Admin Calendar Interface as greyed out or struck-through.

Events that are tagged as “require User to confirm completion” will alert the User every x mina/hours (see Calendar event entry section) until the event has been marked as complete.

VI. Journeys

A Journey consists of Segments that are classed as either Walking or Transit.

There are two types of Journeys in the CCAH System:
Planned Journey. This is a journey from one LOI to another LOI. It is generated by Admin using OTS, scrutinized by Admin and potentially edited manually to improve it. It is then stored in the Database.
Adhoc Journey. This is generated by OTS and is typically from a GPS location to an LOI. The Admin creates this Journey using the Open Trip Planner interface from within the Admin Module.

### View all Journeys

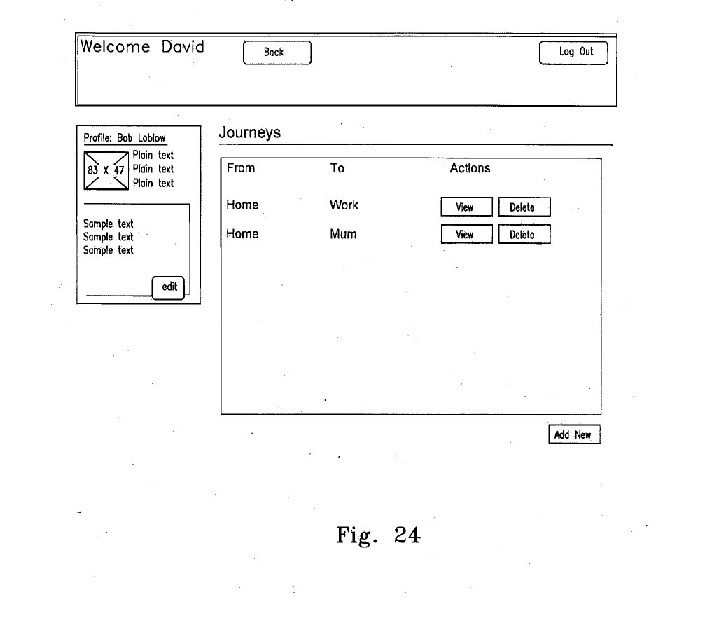

FIG. 24 illustrates the Journey Creation Interface for the system of FIG. 20.

### Creating a New Journey

### Inputs:

1. LOI start
2. LOI end.
3. Date of Journey (this can be the date of the first known use of this journey)
4. Start time of Journey

### Outputs:

A visual representation of the Journey on a map

XML or JSON formatted trip data

Time at which this route may become invalid

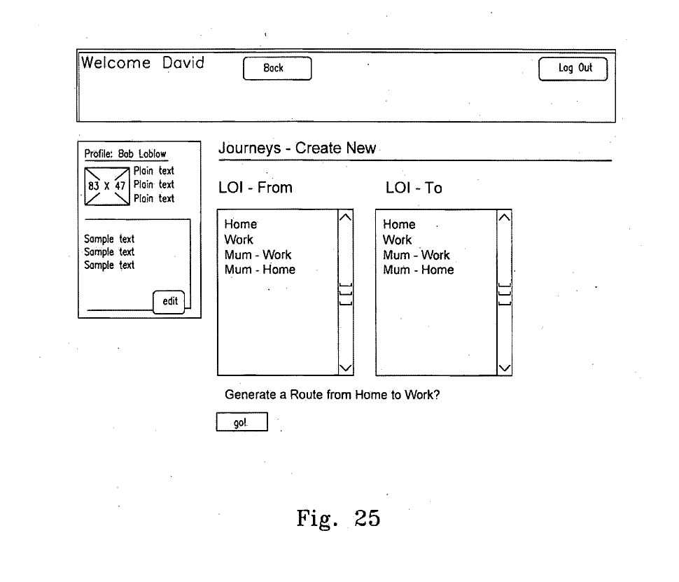

FIG. 25 illustrates a further interface for the Journey Module of the system of FIG. 20.

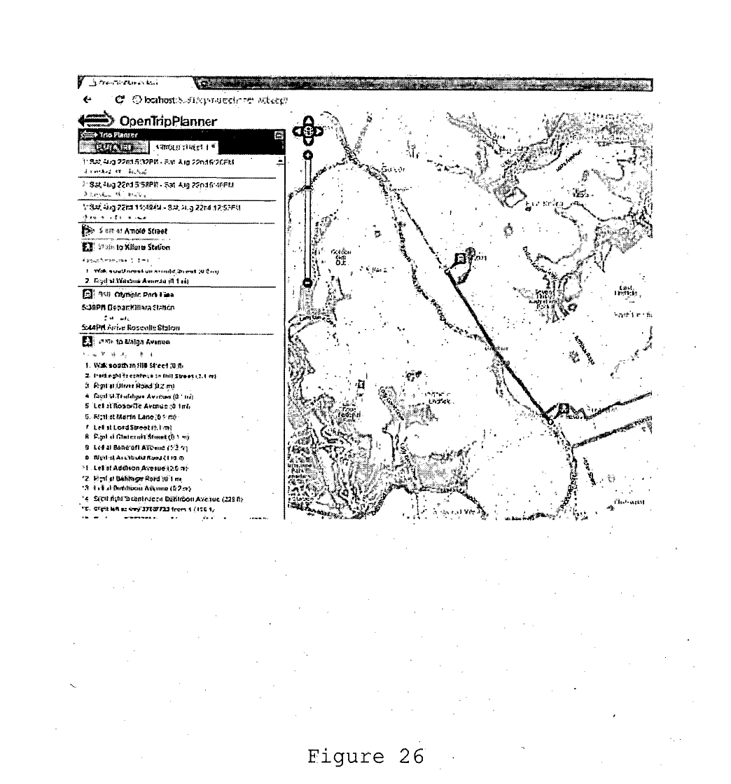

FIG. 26 illustrates a further interface for the Journey Module of the system of FIG. 20.

Calculating when a Route Becomes Invalid

When a planned journey is created by Admin, The CCAH Server first generates the route. Then the CCAH Server must generate the same route multiple times, with each iteration incrementing the start time by 30 mins. In each iteration the resulting route is compared with the first route. If in any iteration the resulting transit segment data is different from that generated in the original route then the delta-time is recorded as the “Valid Time Period” for that route.

Why does this Matter?

Because if a User tries to use a planned Journey outside the time period it was designed for, the bus or train line in that journey may not be active.

### Editing a Journey

If an Admin decides that a walking segment of a generated Journey is not to their liking they can overwrite that segment with a new one generated using Map My Walk tool. The following flowchart shows the process for creating and editing a journey.

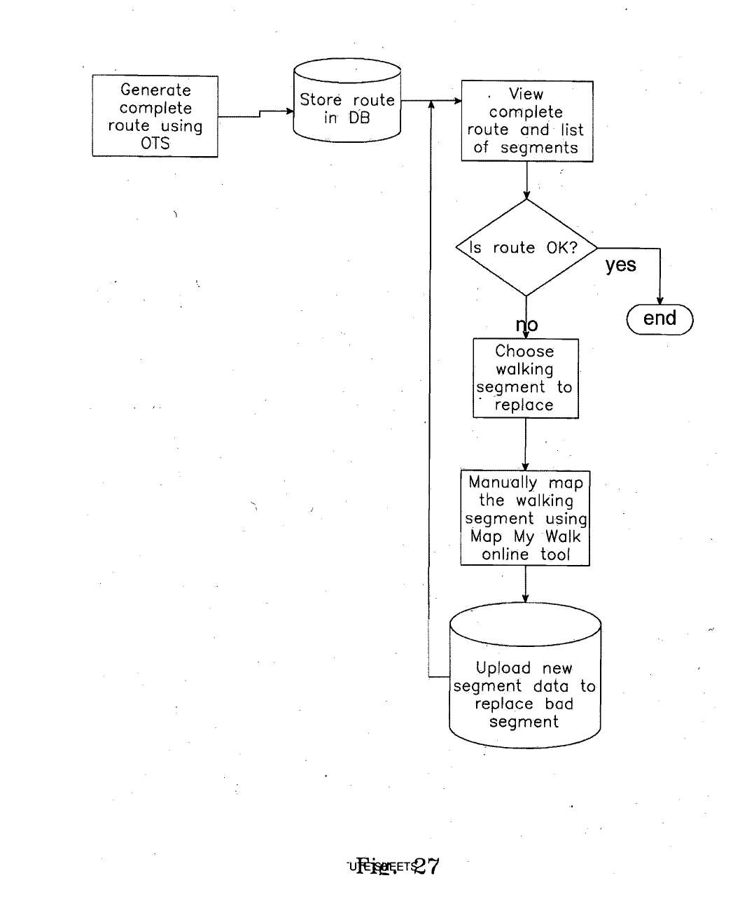

FIG. 27 is a flow chart, in which a journey is created and edited in the Journey Module of the system of FIG. 20

### Creating a Walking Segment

The current method for doing this is to use Map My Fitness to custom build a point-to-point walking segment with meta data. The Tool can be embedded in the Admin Interface using the MapMyFitness iFrame: http://www.mapmyride.com/partner_tool#GET_IT_NOW

example: http://demo.mapmyfitness.com/walking/

Once they have plotted the route, the Carer will click ‘Save’. This saves the route within the MapMyFitness system but not the CCAH database. To get the walking route into CCAH, the CCAH Admin Server will use the Map My Fitness API to access the route and load it into the CCAH database in place of the original walking segment.

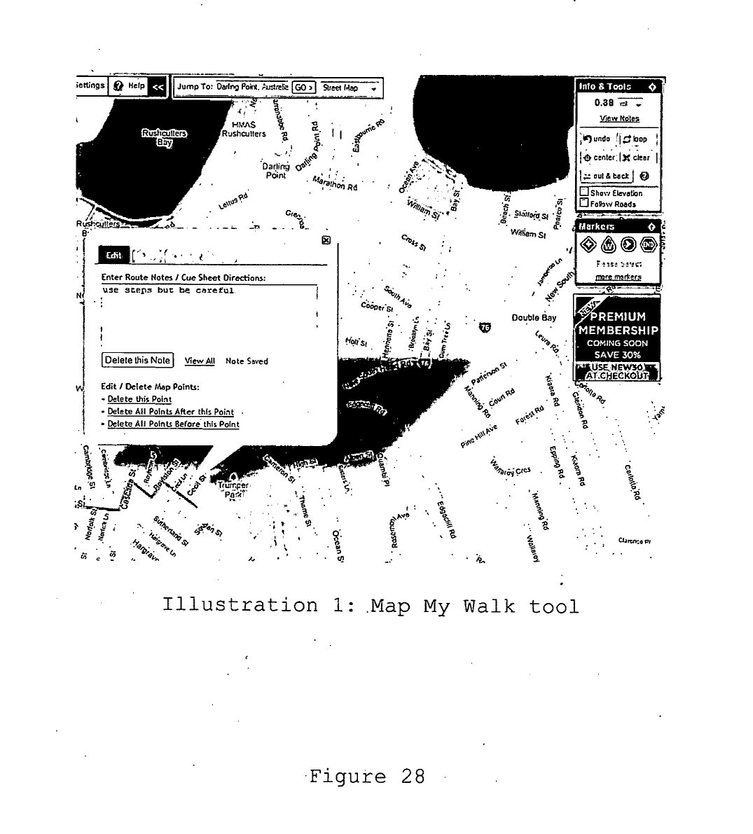

FIG. 28 illustrates the map output from the Journey Module from the system of FIG. 20

The API is just a set of HTTP calls with parameters. See here:

http://api.mapmyfitness.com/3/routes/

Routes can be accessed with the API in GPX, KML, JSON or CRS formats.

```
    GPX formatted route data from MapMyFitness
<?xml version=“1.0” encoding=“UTF-8”?>
<gpx  version=“1.1”  creator=“MapMyFitness.com”
xmlns:xsi=“http://www.w3.org/2001/XMLSchema-instance”
xmlns=“http://www.topografix.com/GPX/1/1”
xsi:schemaLocation=“http://www.topografix.com/GPX/1/1
http://www.topografix.com/GPX/1/1/gpx.xsd”>
  <trk>
    <trkseg>
```

| | |
|---|---|
| <trkpt | lat=“−33.88429332702753” |
| lon=“151.1985683441162”/> | |
| <trkpt | lat=“−33.88418644649098” |
| lon=“151.2014651298523”/> | |
| <trkpt | lat=“−33.88395487153578” |
| lon=“151.20221078395844”/> | |
| <trkpt | lat=“−33.88309091327142” |
| lon=“151.2017011642456”/> | |
| <trkpt | lat=“−33.88226257393704” |
| lon=“151.2011754512787”/> | |
| <trkpt | lat=“−33.882627756785304” |
| lon=“151.2004566192627”/> | |
| <trkpt | lat=“−33.882725732405504” |
| lon=“151.20044589042664”/> | |
| </trkseg> | |
| </trk> | |
| </gpx> | |

VII. View Updates

Some users are permitted to add and edit Calendar Events and Contacts from within the App. While Carer does not need to approve those edits, they can view them and remove them if required. A User is not able to delete

Calendar Entries and/or Contacts, this can only be done by a Carer.

Items listed in Updates:
New or edited Contacts
New or edited Events
Adhoc routes requested
Last known actions made by the User on their device (last 24 hrs of actions stored—TBD)

The carer will see the list of updates, colour-coded by type and in chronological order, and will use a set of filter checkboxes to refine the view.

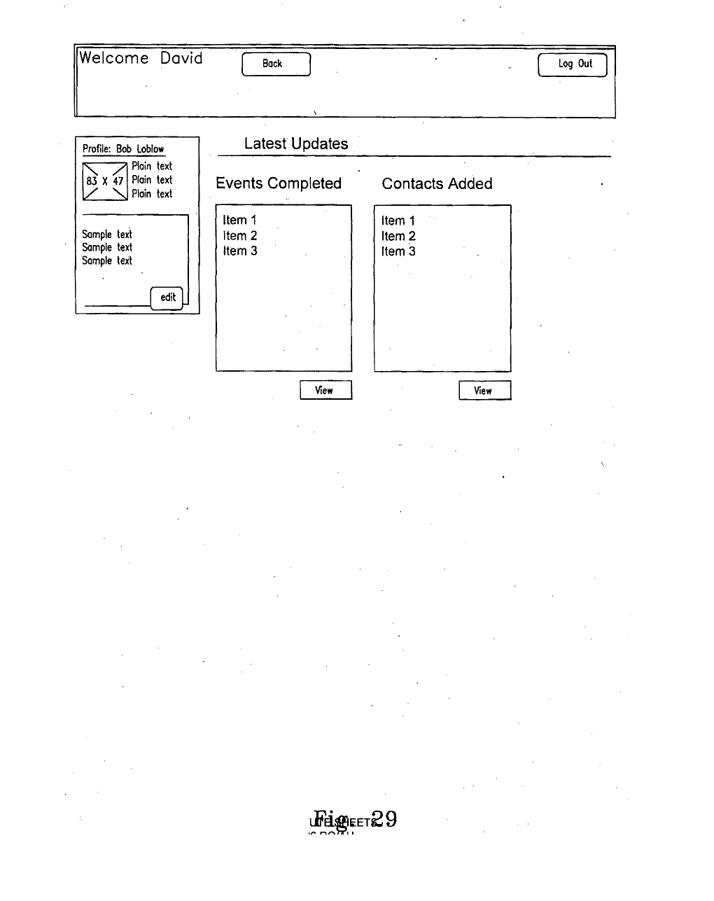

FIG. 29 illustrates the Calender Events Log Interface of the system of FIG. 20.

### CAMS Website Software Requirements

I. Login

II. Show Regional Interactive Map

The primary map view in CAMS will be rendered using Google Maps. The Zoom tools will be available for CAMS Users to set the zoom level. Initial Default will be to State level, and for future logins it will default to their last zoom level and location.

III. View Subsets of Users on Map

CAMS Users can quickly choose to see subsets of Users on the map by selecting from a list:
All (grey icon)
1 hour late for Update (yellow icon)
4 hours late for Update (orange icon)
8 or more hours late for Update (red icon)
Single User (as a result of search) (white Icon)

The map will automatically zoom to bounds that will encapsulate all Users in the subset.

Each user will be visually represented by a clickable Icon and their Name.

User Subsets will initially be defined by Carer name.

IV. Viewing User Profiles

Clicking on a User icon will bring up a popup window displaying summary profile information for that user. This information will include:
Name
Time of last 6 location updates (GPS information sent) and closest approximation of location
Calendar entries for 1 hour on either side of current time
Last four actions undertaken by User on their device
Option to Contact the User (generates a call to the User's device)
Option to view more information about that User (links into admin module)

V. Alerts

The mapping display will also have some in-built ‘alerting’ systems. If a User's GPS location update is more than 2 hours past update time (due to no signal, server down, misplaced device or faulty device), the User will be highlighted on a map. A further alert facility utilises background communications to the user's immediate carer or family alerting them when the user completes regular travel tasks. In one form the targets for the background communication can be derived from contacts lists in the user's social media programs (for example a Facebook contact list).

VI. Instigate a Call to a User

VII. Answer an Emergency Call

### External Interfaces

I. Google Data Protocol

The Google Data Protocol is a REST-inspired technology for reading, writing, and modifying information on the web. CCAH Server, in particular the Admin Module, will make use of this protocol for multiple functions.

Many services at Google provide external access to data and functionality through APIs that utilize the Google Data Protocol. The protocol currently supports two primary modes of access:
AtomPub: Information is sent as a collection of Atom items, using the standard Atom syndication format to represent data and HTTP to handle communication. The Google Data Protocol extends AtomPub for processing queries, authentication, and batch requests.
JSON: Information is sent as JSON objects that mirror the Atom representation.

### Range of APIs Available:

See

http://code.google.com/apis/gdata/docs/directory.html

### Uses of APIs

The Google APIs will be used to access Contacts and Calendar storage for each User via the Admin Module.

### Non Functional Requirements

I. Software Platforms

### CCAH Client App

Android 2.2 (SDK Level 8)

### CCAH Server

Tomcat 6.0
Servlets ?
Linux

### CCAH Admin and CAMS Web App Server

Tomcat 6.0
JSP 2.0
Linux

### CCAH Admin and CAMS Web Site

HTML
CSS
Jquery 1.4.2

### CCAH Database

MS SQL Server
Windows

### Open Transit Server

Tomcat 6.0
Linux

II. Uptime

99.9%-99.99%

III. Server Bandwidth

| | GPS Pings per user per day | | | | |
|---|---|---|---|---|---|
| | 8 | 12 | 24 | 48 | 96 |
| Number of | 100,000 | 100,000 | 100,000 | 100,000 | 100,000 |
| active users | | | | | |
| Total Requests | 800,000 | 1,200,000 | 2,400,000 | 4,800,000 | 9,600,000 |
| per day | | | | | |
| Avg Requests | 9.3 | 13.9 | 27.8 | 55.6 | 111.1 |
| per second | | | | | |

IV. Hardware Requirements

| Component | RAM | CPU Load | Network I/O | Disk I/O | Disk Space |
|---|---|---|---|---|---|
| Client App | Large (16 G) | Large | High (1 Gbps) | Low | Low (<50 G) |
| Server | | | | | |
| Admin Web/ | Medium (8 G) | Medium | Med (100 Mbps) | Low | Low (<50 G) |
| App Server | | | | | |
| Database | High (16 G) | Medium | High (1 Gbps) | High | High (>500 G) |
| Server | | | | | |
| OTS Server | High (16 G) | Medium | Med (100 Mbps) | Low | Low (<50 G) |

V. Security

While the Admin Website and CAMS will be made secure through standard login and session management procedures, the Web Services that are accessed by the CCAH App need to have some sort of security to stop outsiders from exploiting the data.

### Third Embodiment

### The Virtual Community

I. Outline of Technology & Concept

### General Concept Outline

The Virtual Community web based application development has the following technical objectives.

Develop a 3D Virtual Community in which people with disabilities can plan and practice activities encountered in everyday life, undertake experience based learning, practice and enjoy a range of real community skills in the safety of virtual environment.

The system offers a rich and detailed virtual simulation of a community comprising of nested environments which relate to each other and which mimic the real world. In a variety of neighbourhood environments (home, local suburb, wider suburban centres, CBD and the wider country) people will enter an environment that includes real life learning around choice, decision making and an understanding of the consequences of individual actions which arise from a lack of understanding of the unwritten rules of society and the effects that these have on the acceptance of their presence in the community and upon their relationships with other people.

In addition, the design of the Virtual Community allows the merging of the ‘Virtual World’ with reality through the seamless interface with real life. This will allow users to learn from their experiences that occur in the virtual environment and to generalise these experiences into the real world—thereby cementing the learning and allowing for increased understanding of the ‘community’ and ultimately increased independence.

This generalisation will be further reinforced through the development of a software application which will reside on a mobile, touch-screen, handheld device. This will allow the user to apply the concepts taught in the Virtual environment in the actual community. This device will reinforce the learning outcomes by closely mirroring the Modules that appear in the Virtual Community. It is envisioned that this handheld device will eventually interface with the Virtual Community, providing feedback to the user about progress and eventually allowing rewards to be provided to the user based upon actual progress in the real world.

The Virtual Community will provide a framework that allows modular extensibility within the main environments of sub environment, scenes, scenarios and user feedback (user prompt, check lists, how to pages, learning modules) linked to capability profiles and user accounts. Within the application the user may print Check Lists, How To pages and Learning Modules. Selection of learning scenarios will be via side menu list and or point & click of key objects.

The application will allow variation of Menus and User Feedback conditional to disability profiles, skill levels and system heuristics linked to account hence enabling skill based progressive learning differentiated by disability type.

The user perception of the application is expected to be supportive, coaching, self-paced, instructive, yet entertaining. Hence How-To pages content may lean towards leisure and diversion, Learning Modules tend towards instruction and Check Lists are pragmatic in nature.

II. Outline of Technology

The Virtual Community is comprised of two separate elements—the Virtual Community and the Handheld Support Device.

### The Virtual Community

At its base, the Virtual Community comprises a rich 3D Virtual Environment. The potential areas which we believe might constitute unique inventiveness lies in the combination of several key elements of the system which will allow for the learning experiences to be generalised into the real world.

Interface with government portals—Modules within the Virtual Community will interface with various Government Portals (such as Centrelink, Department of Housing) to allow users to understand the functions of these entities and to understand their rights and responsibilities therein. Linking program modules will be developed (in some instances) which will allow users to directly interface with the ‘Live’ environment from within the Virtual Community.

Use of Corporate Branding—Certain key modules within the system will be sponsored and branded by key corporate suppliers. For example, the Shopping Module may be sponsored by Coles or Woolworths. In this instance the virtual store will incorporate a layout, and branding that will mirror the actual layouts and experience of shopping within an actual Coles or Woolworths store. Similar sponsorship and branding/layouts will occur for other key ‘destinations’ and environments within the Virtual Community (e.g.—Banking, Pharmacy, taxis, and so on). This will aid in the generalisation of the learning that occurs within the virtual environment as the virtual ‘destinations’ within the system will mirror the real destinations.

The Virtual Diary—The Diary is the primary planning function for Users in the system. It combines system generated variables (such as Day, Weather) and prompts for Users which are generated from the User Profile (eg—Work Days). In addition the Diary acts as a gentle reminder tool for various other modules in the system (such as a reminder if a User has not undertaken various tasks within a predefined period such as shopping, or Housekeeping Tasks). Users can also add tasks to the Diary as they progress through various modules and scenarios within the system which then appear as Reminders on the Diary Page. It resides physically in the virtual world on the Desk at the User's Home and is visible as a link on all pages. The Diary also serves as the entry point into the various modules within the system. It also serves as another reminder of what must be done today—and in effect becomes a “Day in the Life of” type list allowing Users to select items that must be accomplished in a typical day. Once the User selects an activity the system then exits the Logon/Day Preparation environment and then drills into the particular Environment/Sub-Environment associated with the selected module (eg—the Home/Lounge Room).

System Heuristics—The system must accommodate users with vastly different disabilities and capabilities. As such the system must be able to vary the display based upon the input and interaction of the user. This will initially be based upon a typical user registration page which will define a user profile based upon answers to a series of questions. However, over time this function must evolve to allow the system to customise the teaching experience based upon the actual user input.

The Handheld Device has been Described Earlier:—

The Handheld Device encompasses a customised application which resides on an iPhone style device. The application may be developed to include the Windows Mobile, Symbian and Anrdoid operating systems in addition to the iPhone operating system. The mobile device application provides seamless integration for users between the learning outcomes of the Virtual Community and real life. At its most basic level the application will provide for a digitalised version of various memory and match to sample style aides that are currently used to train people with disabilities to accomplish various tasks such as using public transport, shopping, banking, etc. However, the functionality of the application will allow the device to act as a virtual support worker, prompting the user to successfully achieve certain tasks.

### Hardware Platform

The hardware platform may be a standard iPhone style device. It must include the following:
GPS receiver
Wireless connectivity (3G/EDGE/WiFi)
Accelerometer
Touch screen interface
8+ hour battery life
Integrated Camera (>2 megapixel)
Speaker with headphone jack

### Software Platform

The software is simple and icon based. Suitable platforms include:
iPhone (>OS 3)
Symbian
Android
Windows Mobile

### Modules & Functionality

The modules to be developed within the Mobile Device Application closely mirror the modules that appear in the Virtual Community—however, they will allow for users to apply the learning from the Virtual Community in the real world. A brief outline of the functionality of some of the modules is listed below:

### Transport

Use GPS to determine user location
Map key locations by co-ordinates (home, work, doctor, friends, etc)
Select destination by predetermined icon set
Overlay journey
Look up timetables & display next available at location with countdown timer
Advises of next stop and re-route if overshoots end point
Some interaction with ticketing top up advisor

### Shopping Modules (Sponsored)

By store layout/aisle
By category
By recipe
Running total if possible
Link to Budgeting Module
Link to Health & Nutrition Module

### Health & Nutrition

Recipe creation with Calorie Counter
Diabetes monitor
Exercise module with rewards
   a. Link with pedometer or maybe with internal device accelerometer
   b. Link with Virtual Community for rewards based upon achievement of predefined goals
Link with shopping module (shopping list)

### Meal Preparation Module

Recipe creation
Food Inventory List—Links to Shopping List in Shopping Module
Step by step cooking tips

### Banking

Link with budgeting module
Link with Shopping Module

### Lost Function

One button push to call for help back to office
Returns GPS co-ordinates and unique IMEI number to office
Overlays co-ordinates onto map to display person location

### About The Virtual Community

The applicant has developed the Virtual Community that will change the way that people with disabilities interact with their environment. Using gaming technology, people will be able to plan and practice home and community activities that are encountered in everyday life. This will offer people a range of experiential learning opportunities through an unprecedented platform for exploring the world around them. Because of the nature and effects of their disabilities on their lives many people, particularly those with intellectual disabilities and/or physical disabilities have not previously been able to gain such skills whilst people with brain injuries need mechanisms to relearn skills.

We are offering a rich and detailed virtual simulation of a neighbourhood that includes real life learning around choice, decision making and understanding the consequences of individual actions. Many people do not understand the unwritten rules of society and the effects that these have on their acceptance of their presence in the community and upon their relationships and consequent relationships with other people.

When a person interacts with The Virtual Community, they can do so through many different layers, depending upon their ability to use the technology and level of engagement. At all layers of the program they will be able to explore and test out, in a fun, safe and graphically rich environment, aspects of the world they may never have been exposed to before.

I. Overview

The Virtual Community web based application development has the following technical objectives.

Develop a 3D Virtual Community in which people with disabilities can plan and practice activities encountered in everyday life, undertake experience based learning, practice and enjoy a range of real community skills in the safety of virtual environment.

Eventually, we will offer a rich and detailed virtual simulation of a community comprising of nested environments which relate to each other and which mimic the real world. In a variety of neighbourhood environments (home, local suburb, wider suburban centres, CBD and the wider country) people will enter an environment that includes real life learning around choice, decision making and an understanding of the consequences of individual actions which arise from a lack of understanding of the unwritten rules of society and the effects that these have on the acceptance of their presence in the community and upon their relationships with other people.

Provide a framework that allows modular extensibility within the main environments of sub environment, scenes, scenarios and user feedback (user prompt, check lists, how to pages, learning modules) linked to disability profiles and user accounts. Within the application the user may print, Check Lists, How To pages and Learning Modules. Selection of learning scenarios will be via side menu list and or point & click of key objects.

The application will allow variation of Menus and User Feedback conditional to disability profiles, skill levels and system heuristics linked to account hence enabling skill based progressive learning differentiated by disability type.

The user perception of the application should be that it is supportive, coaching, self-paced, instructive, yet entertaining. Hence How-To pages content may lean towards leisure and diversion, Learning Modules tend towards instruction and Check Lists will be pragmatic in nature.

II. User Interface

### Welcome Page

The welcome page will be a 3D terrain map image of the Virtual Community, with rollover links to My Home, My Street, My Suburb and My City. This should be a high-resolution quality graphic with animated trees, birds, cars, people, etc to “simulate” a live real world environment.

Initially, two Primary environments will be detailed; they are Home and Street, although access links will be provided to all environments (including suburb and city) within the home page.

### User Profiles & Registration

Initially two profile types will be required, “Acquired brain injury” and “Intellectual disability”. The difference in these two profiles will only be slight, navigation menus will remain the same but there will be variations in Prompts and Check Lists. Animations and scenes will be the same.

Registration will either be by manual set-up or online PHP form. User online usage will need to be actively monitored and measured for later max time and also possible time based charging.

### User Access and Preferences

User access will be allowed via logon and or hot spot links to log on page.

User will be able to select avatar, skill and mood. Go to options will be either Environment or suggested links.

### User Modes & Perspectives

There is to be three operational modes in this embodiment:
Show Me

Essentially this is a play through mode that when a Lesson or Scenario is selected the application will run through the sequence with text and audio prompts at each significant point of the sequence. This mode is depicted ‘mostly’ in the 3^{rd} person visual perspective.

### Teach Me

This mode stops at each significant point within the sequence with additional button on the screen to step through one step at a time. Text and Audio prompts will be provided to guide the user (as in show me) along with warnings determined from the Use Case consequence list. This mode is depicted in a mix of 1^{st} and 3^{rd} person visual perspective as appropriate to show any needed detail while retaining scene context (technically this can be done by shifting the virtual camera angle).
Let me do

This allows the user to control the sequence flow and order of the steps. This mode does not give the standard prompts but will give danger warnings as determined from the Use Case consequence list. Non compliance with the appropriate sequence will incur demerits (as defined in the Use Case) which could possibly translate into actions or other lessons. This mode is depicted mostly. in the 1^{rd} person visual perspective.

### Animated Components

### Environments/Sub Environments

Home Environment
Kitchen
Front Door
Lounge room
Street Environment
Front Yard to Street
4 Lane busy Main Street, T intersection & Calder sac
Traffic Light intersection with lights based pedestrian crossing (push button Crossing Signal)
Bus Stop & Shelter
Inside Bus
Corner Shop
Diary

The diary in Stage 1 will be a mock up to represent start up navigation, user information and suggested links to scenarios. Future intent of the diary function is outlined below for information only.

The Diary is the primary planning function for Users in the system. It combines system generated variables (such as Day, Weather) and prompts for Users which are generated from the User Profile (eg—Work Days). In addition the Diary acts as a gentle reminder tool for various other modules in the system (such as a reminder if a User has not undertaken various tasks within a predefined period such as shopping, or Housekeeping Tasks). Users can also add tasks to the Diary as they progress through various modules and scenarios within the system which then appear as Reminders on the Diary Page. It resides physically in the world on the Desk at the User's Home and it should be visible as a link on all pages. The Diary will also populate suggestions in the What Would You Like to Do Today page which follows the Reminder Page.

### Interactive Scenarios Modules (Sequences)

### “Leaving Home to Catch the Bus” Environment (HOME)

A1 Scenario Template (getting ready to leave)—Scene (Lounge room)
A2 Scenario Template (leaving home)—Scene (front door)
A3 Scenario Template (walking onto My street)—Scene (street beginning)
   “Walking to Catch the Bus and Getting on” Environment (STREET)
B1 Scenario Template (walking down My Street)—Scene (road/crossing)
B2 Scenario Template (waiting at bus stop)—Scene (bus stop)
B3 Scenario Template (getting on bus)—Scene (inside bus)

### Check Lists

Links will be provided to nominated check lists, text and format to be provided by client.

### How to Pages

Links will be provided to nominated How To pages, text and format to be provided by client.

### Learning Modules

Links will be provided to nominated Learning Modules, text and format to be provided by client.

### Environment Definitions

My Home

My Home—a house created individually for each participant where they can set up their house, furnish it as they wish, invite people over, cook and prepare meals and learn domestic routines. As such the My Home environment is a cornerstone environment.

The intention is to ultimately have a variety of basic home designs that equates to a typical streetscape, including single level and multi-storey multi-bedroom suburban homes, and in at a later stage a semi high-rise block of flats, with likely a single bedroom unit. In terms of Stage 1—style likely construct will be in alignment with building and interiors of accommodation from the period between 1970 and 1990. Beyond Stage 1 the style alignment will be a mixture of any style homes from Federation style through to modern designs. In the home there will be a bedroom, bathroom, kitchen, lounge room, laundry.

My Street

My Street deals is closely associated with My Home but with public spaces, the local park, corner stores, local traffic and some road rules including lights and pedestrian crossings and some day to day interaction with other people and neighbours. In essence environment within walking distance from home.

The street style is to be a typical suburban street, row of single level homes, lawns, gardens, driveways, garages and sealed footpaths with some trees. The my street environment should be a single street with a Calder-sac at one end and T intersection at the other with a Corner shop on one side of the intersection and a bus stop to the suburb/city across the road via a set of traffic lights to accommodate pedestrians crossing. The main street (intersecting with the Calder-sac) should be a busy 4-lane road. There should be a Service Station on the other side of the street to the Calder-sac on the other side of the intersection to the Bus Stop/Shelter

My Suburb

My Suburb expands the street environment to add supermarket shopping, specialist shops, banks, post offices, public and private transport scenarios. This level will include socialising, meeting friends, churches, police stations, local health professionals and hairdressers. The significant environment threshold between Street and Suburb is proximity and transport. However there should be an allowance made for people to walk between the thresholds between Street and Suburb.

My suburb will have a range of traffic scenarios, bus stops, car park, and train station. It will also have a variety of shops, butcher, grocer, supermarket, cloths shop, banks, ATM, Real-estate, Medical Centre, Laundromat and hairdresser.

My City

My City starts to look to the wider world and touches on issues such as hospitals, theatres and cinemas, employment, CentreLink, public transport hubs, restaurants, large shopping centres/multiplexes, the Town Hall, Public Libraries and Museums, Botanic Gardens, the Opera House and so on.

Contemporary Australian City with large corporate office building, major retail shops, cinemas, hospitals, courts, major roads and highways, airport, trains, buses, ferries, taxis, parks, gardens, and many people and queues.

My Country

My Country will develop the national perspective of community—understanding the levels of government, citizen responsibilities such as voting, tax, the legal system and individual rights.

### Sub Environment Definitions

Lounge Room

The living room has a warm and cosy feel with a two seater couch, coffee table, television, desk with office chair, telephone, computer, two armchairs, a bookcase and a stereo. The floor is carpeted; the walls are a creamy white colour and one of these walls houses two large windows. The television is against the back wall with the couch directly in front of it in the centre of the room with an armchair on either side of it. The coffee table is situated in between the couch and television. To the right of the television is the desk, which has the computer, Telephone and stereo on it along with the office chair tucked underneath the table. Central to the desk is the Diary which is the central planning tool within the system.

Desk

A standard office desk with a standard office chair, situated on the desk is a phone, clock, calendar, bus tickets, a diary and the users wallet and photo ID.

Front Door/Hall

A standard front door with a simple lock mechanism and door knob and door bell to the right of the door, as you enter the hall there is a small bench with a key bowl etc, the hall has an entrances to the bedroom on the right whilst the end leads off to the kitchen/lounge room.

Kitchen

An “L” shaped kitchen with a sink, microwave, toaster, kettle, double door fridge and kitchen table with chairs, which is next to the bench.

Front Yard to Street

A picket, fence surrounds the house front yard with a gate that leads to a concrete pathway from the front door. The gate should have a simple locking latch on it to secure it in a closed position

Street

Standard street with single storey houses and front lawns on one end is a cul de sac and the other end is a “T” intersection with a corner shop on one corner and a pedestrian crossing along with traffic lights on the other leading to a bus stop.

Bus Stop

The bus stop has a small bench and a shelter covering the bench with a bus stop sign to the right.

Bus

A standard single level bus with seats, two doors. The Bus must display a Route Number and destination at the front and at the side near the front entrance

Corner Shop

A small shop with basic general goods and food items.

Service Station

A mid-sized 6 pump (2 lanes with 3 pumps per lane) service station, including a convenience shop with basic general goods and basic convenience food items available for sale

### Overview

The following Business Requirements Specification (BRS) is the high level outline of the components and deliverable to be provided for the Virtual Community Stage 2 development.

### Main Components

I. Registration & Preferences
II. Day Diary activation
III. Programs
IV. Themes & additional sequences
V. Other additional sequences and scenarios
VI. Additional Avatars & Animations
VII. Heuristic additions
VIII. Sponsorship & Linkages
IX. Environment Extensions
X. Sub Environment Extensions
XI. Free play extensions and Events
XII. Interactive “How To” learning lessons
XIII. Reward games
XIV. Linking elements of the Virtual Community to the Handheld application (Profile Level)

### Component Details

### Registration & Preferences

Development of registration preference page to allow registration set-up and user modification of preferences affecting the User Profile to further extend Disability including changes to the mobility of the avatar, Avatar/Gender (with displayed image), Care Requirements, Habitat, Themes (one per day of the week), Interests, Programs, Employment and Skill. These are based on the Excel document attached

### Day Diary Activation

Activation and development of full diary mode including animation of diary active for all diary “days” (day of week only) with ‘Theme’ based “suggested activities” as To Do pages for each day of the week. Day schedule entries to be auto filled from preference Programs which will be sets of time related tasks (to be defined) but which will not link to activities in the VC, Suggested Activities page (for each day) (i.e. To Do) to be auto filled from selected preference Themes which can be defined for each day of the week (details to be defined). (Note: A Theme being a grouping of Sequences or Scenarios and a Program being a timetable related to a set of tasks which does not link to Suggested Activities)

### Programs

Programs are a set of time/day based activities which are stored in the application and mapped against day of week and time of day for each selectable program. Programs are selected from the Registration Preferences page. For example, Security, Getting dressed, Personal Care, Preparing Meals, Going to work/out, Tidy House, Wash & Hang Out Clothes, Wash Up Dishes & Clean Kitchen.

### Themes & Additional Sequences

Movement to a stronger ‘Theme’ basing as the core component of the Virtual Community in determining user activity. This will include additional and expanded themes including Travel, Street and Shopping sequences and expansion of current Travel Theme to include “Catching a train from Suburb”. There will be the addition to My Street Environment to include “Going to the park” and, also in My Street, the creation of the first Shopping Theme of “Shopping at the Corner Shop” with this extending to the development of “Window shopping at my Suburb”.

### Other Sequences and Scenarios

Proposed additional sequences (subject to definition) include; Posting a letter; Going to the ATM; Going to the shop, finding it closed and checking when it is open; Read advertisements in the shop window; Buy a newspaper; Check the Bus and Train connections; Deal with an emergency situation (eg cat up a tree); Finding something on the street and returning it; Purchase a cup-of-coffee; buy takeaway food

### Additional Avatars & Animations

Development of a single set of additional avatars, male and female with physical disability eg, “sticks” or wheelchair. This would include development of the appropriate animation of the avatar as defined by their mobility options.

### Heuristic Additions

Additional scoring of Check List, E-learning and How to options. Simple score increment for execution of these activities. Sponsorship and Linkages

Buildings rendered in the 3D environment will have special hidden markers related to images (eg logos). Selecting these images-will open a link in a new browser. The image and the related URL will be loaded from a remote file and can be changed without a rebuild of the application. The images or logos will normally relate to a sponsor.

### Environment Extensions

Rendering of Suburb environment including: Clothes shop(s); Shoe and/or Book shop; Butcher; Grocer; Cafe (small restaurant); Take away (may be part of cafe); Supermarket (small); Bank with external ATM; Real-estate agent; Medical centre/doctor; Laundromat; Hairdresser; Post Office; Hardware store; Gift Shop; Train station and Train. Three of these will be internally rendered with the rest external appearance only.

Rendering of My City environment to include train station, skyscrapers, hotels, major banks, hospital, cinema, office building, shopping mall (or department store). These will be external facade only for Stage 2.

### Sub Environment Extensions

Complete rendering of Corner Shop including shelves, products, till, shop keeper, newspapers, fruit, signage etc. Additional sub-environments in My Home (bedroom, laundry, bathroom) and rending of Park in My Street.

Note: these are in addition to the sub environments created as part of My Suburb.

### Free Play Extensions and ‘Events’

Enhanced and additional free play elements where the user is able to walk around an environment and interact with elements and objects. Additionally, there will be a series (minimum five) ‘randomised’ actions which take place in the Virtual Community which require an unplanned or unscripted response from the user. These may include: finding an addressed envelope on the street (user should post this); dog lunges at player and player chooses how to respond (eg walk away, not kick the dog). These are designed to allow real life situations to be sampled in the Virtual Community

### Interactive “How To” Lessons

Discrete modules which access web pages containing information structured for learning with validation of the learning. This could be in the form of multiple choice quizzes, tests or other forms of ensuring the user comprehends the information. Initial module to be ‘Your Responsibilities with Services Staff’ based on content provided by CCA.

A ‘lesson’ template will be created which will allow ‘How To’ lessons to be created and supplied as part of the How To options in the Virtual Community. For Stage 2, there will be up to six interactive lessons. These will be provided in the form of structured units, each of which will be followed by a test or quiz of some sort which will test the user comprehension of the information. Points associated with this will add to the user score.

### Reward Games

A web (non Unity) game developed as pure play (eg Wheelchair Races). This will be a racing game where the user directs their vehicle across a slalom path without crashing and to gain points. It is highly replayable.

Additionally, there will be a simple Unity game where the user is required to collect items and place these in the right location This may be linked to a How To lesson (passive or interactive) and will have an element of learning included in it.

### Linking the Virtual Community to the Handheld Application

There will be a degree of file sharing between the two applications. This will initially be the Profile data which will allow for a single user to be identified between the two applications.

### Social Connection (for Community)

Creation of a social communication space allowing participants to safely chat with other participants in (Twitter like) chat room. Includes friending, blacklist word checking, post- and user-moderation. (Note: Moderation handled through CAMS (Admin Central)—Central Administration Monitoring Service)

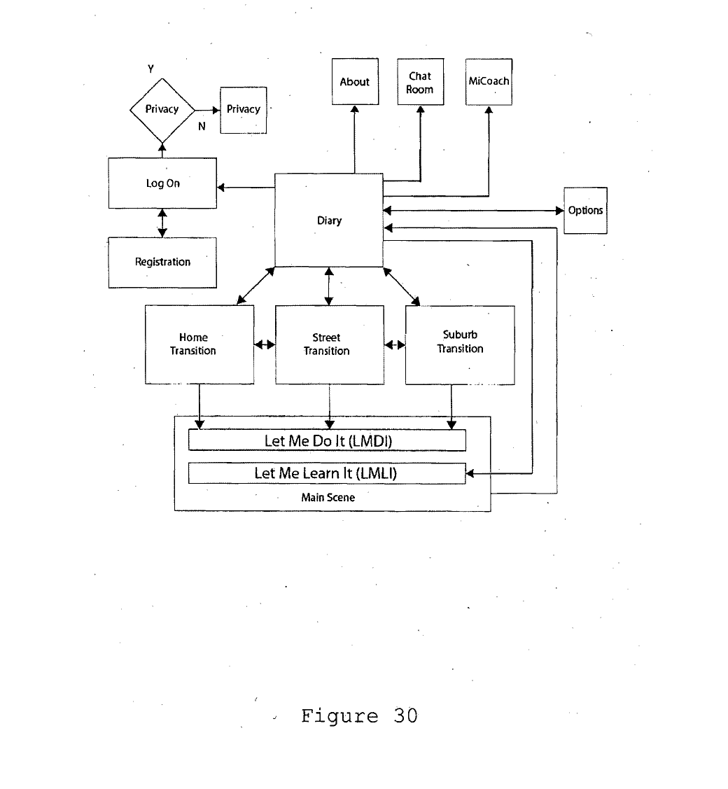

FIG. 30 is an exemplary Log-On page for the Virtual Community according to an embodiment of the present invention.

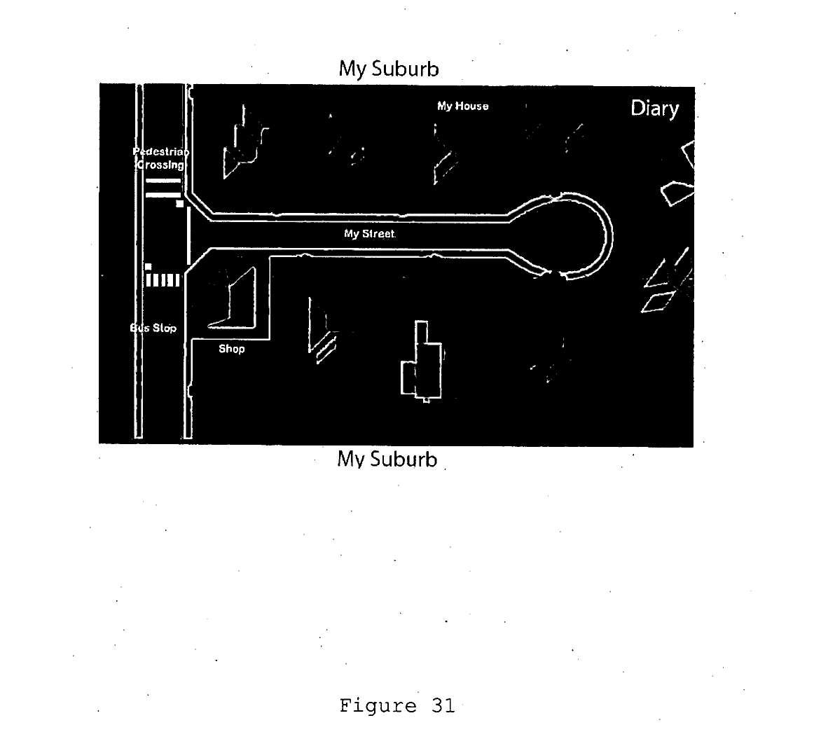

FIG. 31 is a depiction of “My Suburb” environment page within the Virtual Community of FIG. 30.

### Further Exemplary Embodiment

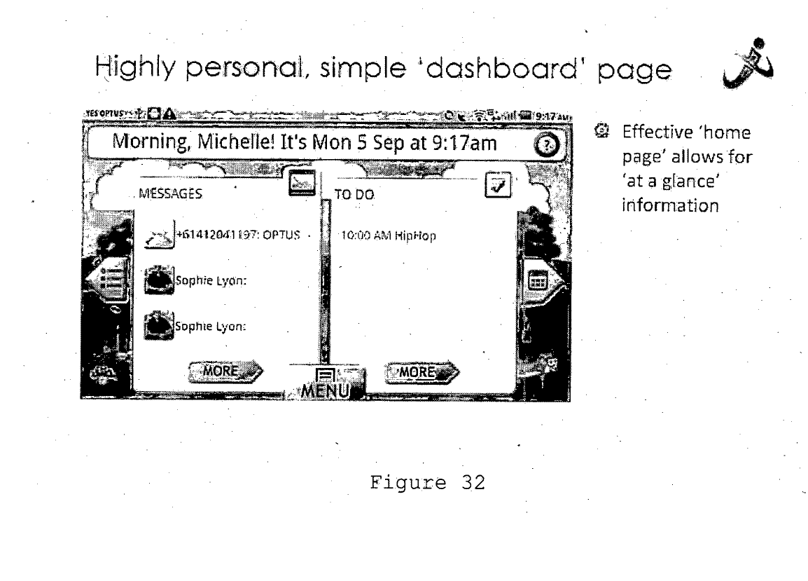

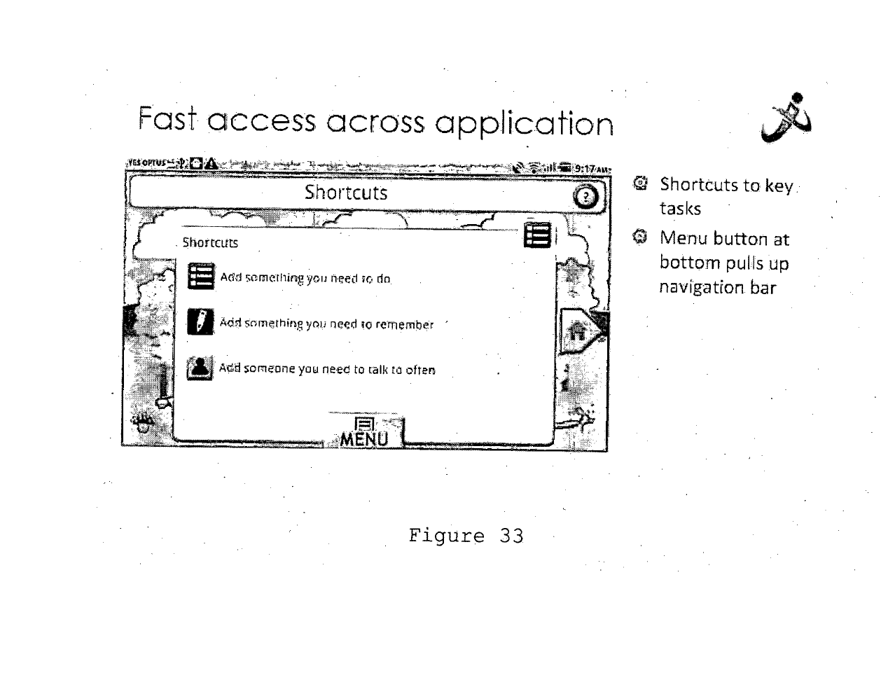

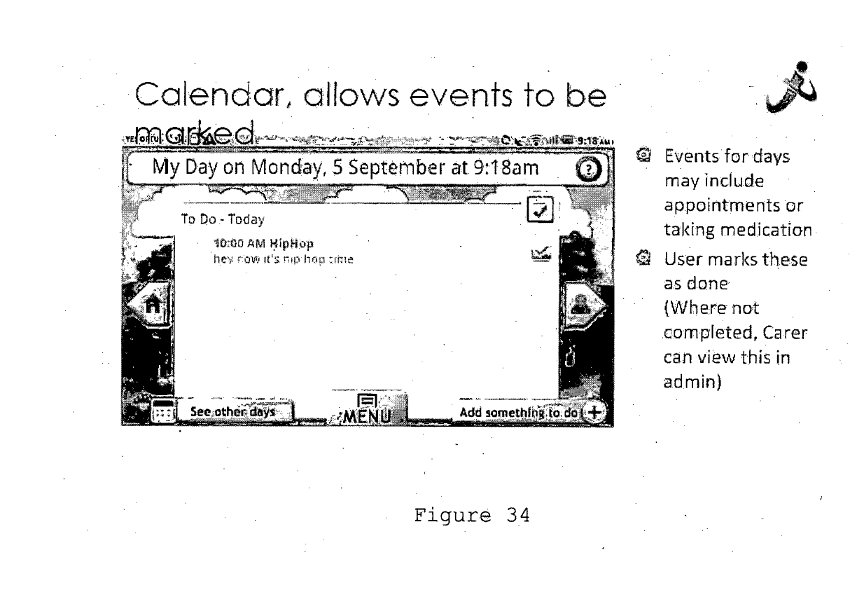

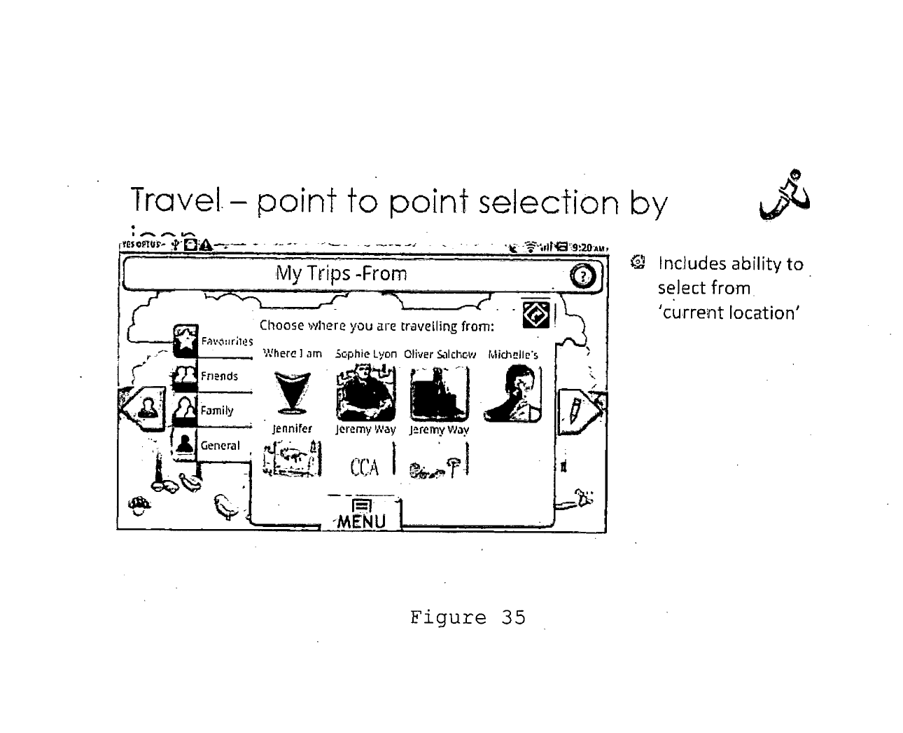

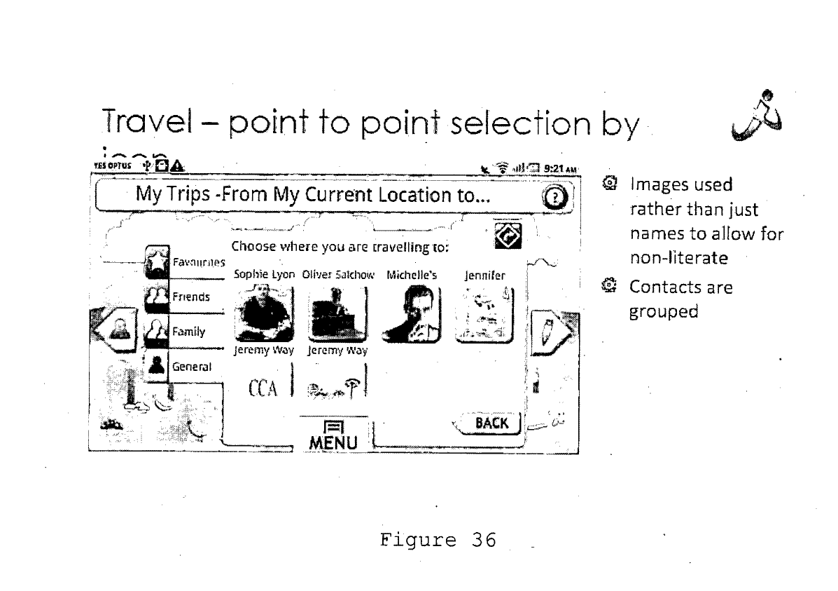

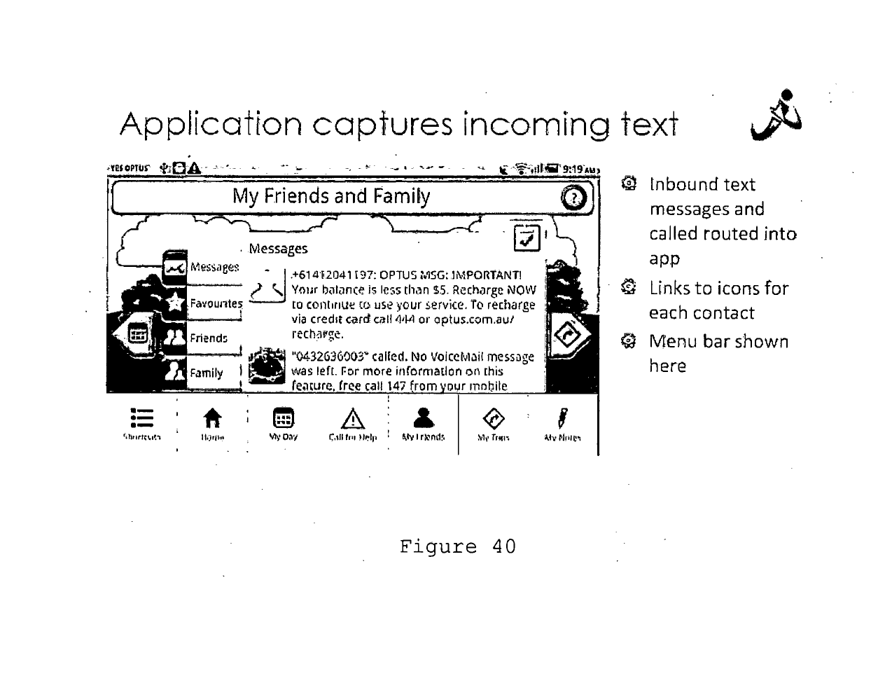

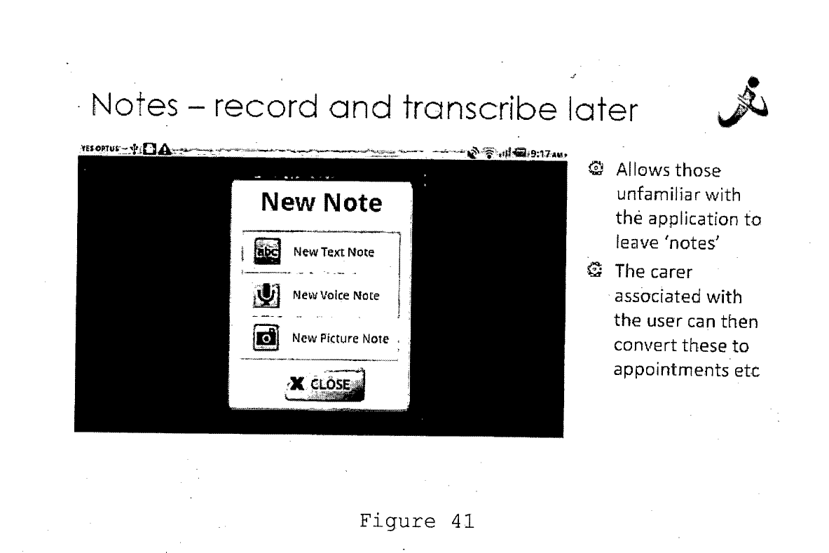

With reference to FIGS. 32 to 42, there is illustrated screenshots of the handheld device in accordance with a further current exemplary embodiment wherein the visual interfaces have been simplified as compared with the earlier embodiments previously described.

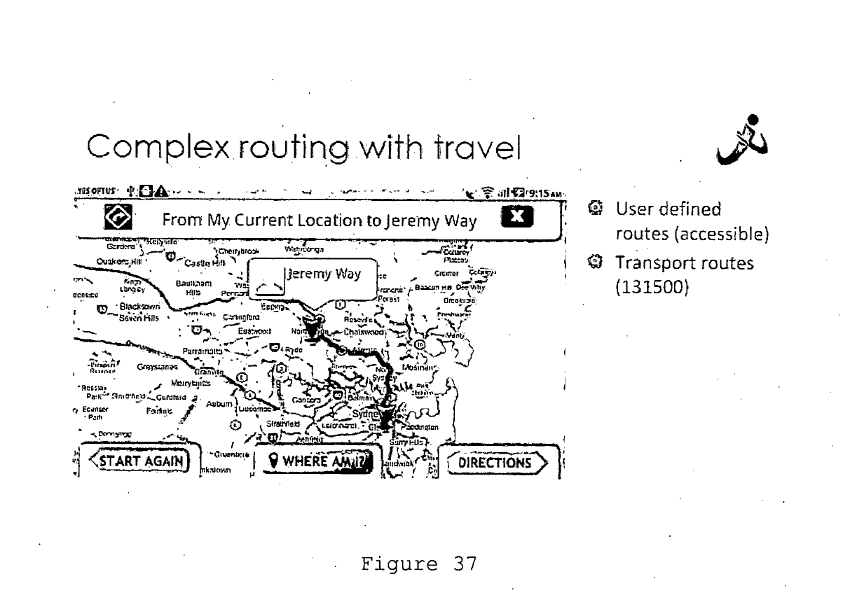

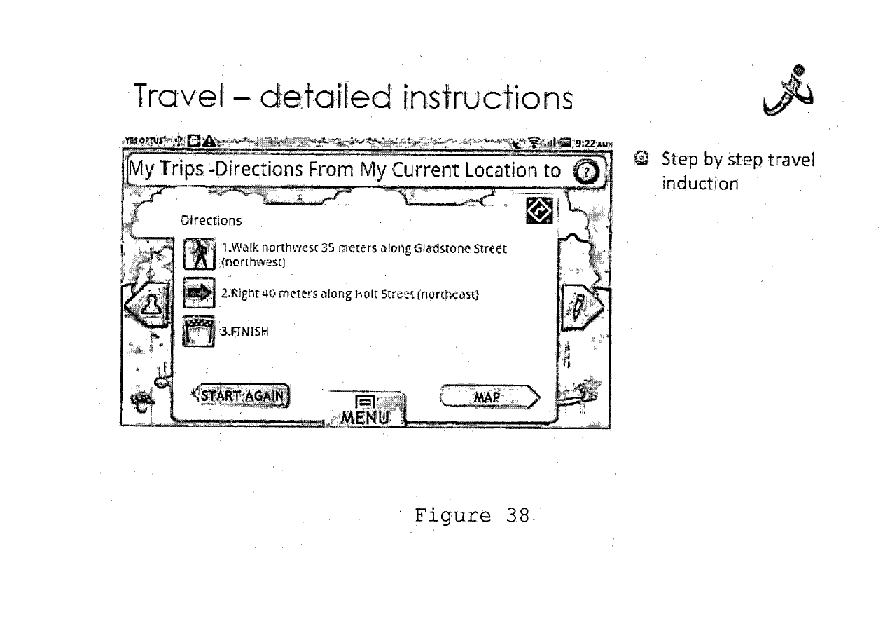

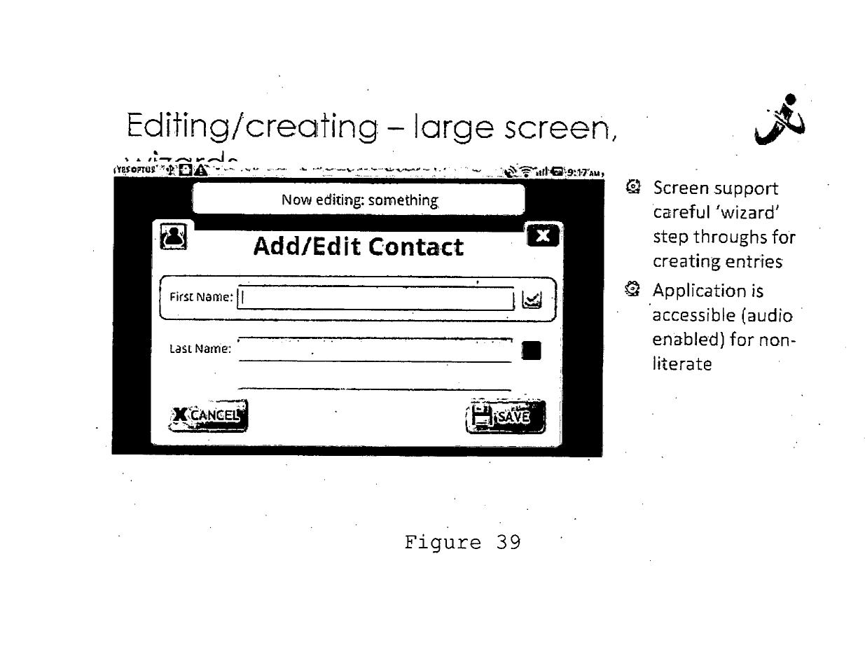

With particular reference to FIG. 37, there is illustrated a presentation of a routing map with directions given in text in relation to that map in part) in the screenshot of FIG. 38. FIG. 39 illustrates a large screen format for editing of scored data within the device.

A restatement of the major features of the system previously described now follows:
Underpinning our service delivery is a philosophy that wherever possible, people with disabilities should be able to live in their own households with the people of their own choosing in the community. However, living within the community and genuinely engaging with the community are often different things. Individual independence is often determined by the degree of engagement within a local community. Thus, our ambition in this project is both straightforward and important—to change the landscape for people with disabilities. We will provide them with independence, the opportunity to grow and to fully engage with their communities.
This is a project that is designed to change the way that people with a range of different disabilities interact with their immediate environment and with their communities. It provides infinite possibilities for people to gain new skills and uncover a range of options which they can embed into their future lives using technology developed particularly to meet their needs and aspirations.
So many people with disabilities find that there are significant barriers to their being able to form supportive relationships within the community. Our Virtual, Community, Social Space and Peer Support Networks will provide opportunities for people to gain social interaction skills which encourage inclusion for them in all aspects of their lives.
Barriers to independence are often linked to a lack of visibility of people with disabilities within the community and a consequent lack of awareness of their individual value to any society. Many people with disabilities have been dependent upon their families or paid staff for support and so lack the experiential learning that most people gain across their lives and lack awareness of the unwritten rules of society that support their inclusion in activities that could increase their range of relationships. Lacking the means to develop a peer network, people become increasingly isolated and dependent upon family members. The Virtual Community and the Mobile Assistant will enable people to plan and practice activities encountered in everyday life, whilst the chat rooms and peer support networks will assist in the exploration of aspects of the world previously denied to them.

Many people with disabilities are unable to access basic services such as transportation or shopping without significant assistance. A current preferred embodiment is an Android-based Mobile Assistant Application and a desktop based Virtual Community application which seeks to address this problem. The Mobile Assistant Application is a customised application which will reside on small tablet style mobile phone type device. The mobile device application at its most basic level will provide for a digitalised version of various memory and match to sample style aids that are currently used to assist people with disabilities to learn and accomplish various tasks such as using public transport, shopping, banking, etc. However, the functionality of the application will allow the device to act as a virtual support worker, prompting the user to successfully achieve certain tasks. This device when linked with the Virtual Community provides a level of generalisation for people with disabilities not in existence anywhere in the world.

Embodiments of the present invention aid to bridge the Experiential Gap by:
1. Providing educational and training support (Virtual Community)
2. Providing an adjunct to, (rather than replacing), the Personal Support provided from Carer or Service Provider
3. Allowing people to bolster their personal experiences enabling them to understand the consequences of their choices and decision-making.
   The Suite of Applications includes:

1. The Virtual Community

2. Dedicated eLearning Modules

3. The Social Space

4. The Mobile Assistant Application

This will allow users to learn from their experiences that occur in the virtual environment and to generalise these experiences into the real world—thereby cementing the learning and allowing for increased understanding of the ‘community’ and ultimately increased independence. This is the first time that the traditional methods of teaching people with disabilities about the world around them have been translated into real time.

The Virtual Community

The Virtual Community is a 3D Virtual Community in which people with disabilities can plan and practice activities encountered in everyday life, undertake experience based learning, practice and enjoy a range of real community skills in the safety of a virtual environment. Using gaming technology, people will be able to plan and practice home and community activities that are encountered in everyday life. This will offer people a range of experiential learning opportunities through an unprecedented platform for exploring the world around them.

Because of the nature and effects of their disabilities on their lives many people, particularly those with intellectual disabilities and/or physical disabilities, have not previously been able to gain such skills whilst people with acquired brain injuries need mechanisms to relearn skills.

The Virtual Community is a rich and detailed virtual simulation of a community comprising of nested environments which relate to each other and which mimic the real world. In a variety of neighbourhood environments (home, local suburb, wider suburban centres, CBD and the wider country) people will enter an environment that includes real life learning around choice, decision making and an understanding of the consequences of individual actions which arise from a lack of experience and an understanding of the unwritten rules of society and the effects that these have on the acceptance of their presence in the community and upon their relationships with other people.

By entering into collaborative arrangements with corporate partners the Virtual Community will simulate opportunities to gain and practice these skills in real life scenarios including:
Retail and Commercial businesses (Banks, Supermarkets, Shopping Centres and Retail outlets) in the local community
Government entities (including Centrelink, Department of Housing and other statutory bodies)
Transportation options (Public Transportation Authorities such as STA for Bus, Ferries and Trains, as well as Private Taxi Operators)
Medial Services (such as Pharmacies, Medical and Dental Centres, Pharmaceutical Companies)

Opportunities will be provided to practice social interaction skills, which require more complex awareness of those relationships, which promote inclusion in many public arenas such as pubs, public parks, music venues, coffee shops and restaurants.

Particular modules address specific skills acquisitions such as health related management fort ongoing medical conditions such as diabetes, asthma, epilepsy and general health and nutrition.

When a person interacts with the Virtual Community they can do so through many different layers, depending upon their ability to use the technology and level of engagement. At all layers of the program, they will be able to explore and test out, in a fun, safe and graphically rich environment, aspects of the world they may never have been exposed to before.

Dedicated eLearning Modules

Within the Virtual Community a series of dedicated eLearning modules are located so as to allow the user to read/view a series of instructions, answer a series of questions and have the system determine missing knowledge areas. The questions are then reformed and presented as a new series so as to advance the users knowledge in the subject. (The eLearning modules will be coded and structured to allow for dynamic creation based on the users' skills and response).

The user's perception of the application is that it is supportive, coaching, self-paced, instructive, yet entertaining. Hence How-To pages content may lean towards leisure and diversion, Learning Modules tend towards instruction and Check Lists are pragmatic in nature.

The Social Space

The Social Space area enables users to engage with their community in real-time within the safety of a moderated ‘Chat-Room’ environment. They will be able to meet people, develop friendships, and understand how to engage with people from different backgrounds to themselves and to begin the process of embedding themselves within their local community in a real and ongoing manner. Our intention is to employ people with disabilities in rural/regional areas to become the local facilitators within a variety of Social Spaces so that they become the guides for other people with disabilities (and the experts) so that over time they will become the ‘go-to’ people within their local community.

The Social Space also integrates Bulletin Board style topics, arranged by categories, which will enable all users of the system—end-users, families, carers and support agencies to easily find the information that is relevant to their needs at the time that they are searching for their individual support solutions. This will encompass a valuable space for the sharing of information and the provision informal peer-to-peer support within the system.

### The Mobile Assistant Application

The Mobile Assistant application provides a vital link between the virtual and real worlds by reinforcing the learning outcomes from the Virtual Community through:
Translating the teachings from the Virtual Community into the real world, providing reinforcement of these elements as and when they are really required—as people step out into their communities.
Connecting people to their communities—by individualising the application to peoples' own real-time needs, preferences and aspirations—thereby making the teaching and the device based support truly relevant to the needs of each person
Providing an iterative, self-paced learning cycle in which the inevitable real world consequences are mitigated and the positive outcomes are reinforced

The Mobile application incorporates various modules some of which include:

Transportation

Diary & Planning

Help I'm Lost Functionality

Shopping (Stage 2)

Budgeting (Stage 2)

Banking (Stage 2)

Health & Nutrition (Stage 2)

Medication Module (Stage 2)

Mobile Assistant Application

The application is designed to be an in-hand assistant covering day-to-day activities (diary); free movement around to work, medical appointments and social locations (transport); assistance with regular activities, possibly as an assistant or as an on-line destination (eg shopping) and a Help/Emergency function.

The Home Screen

The Home Screen is the screen that the application automatically loads. It is designed to be simple to use, intuitive and above all else—human. Messages from Family and wider support networks are displayed on the Home Screen. This allows users to receive text or voice based messages about their day. The To Do List mirrors an electronic diary for the user and is tailored to their day, their reminders and their activities. The diary content is loaded by either the user or if necessary, a support person using a remote administration system and mimics the user's diary. The content in the diary is updated over the air to the application.

The Home Screen (refer to FIG. 32) lists what will happen that day; the reminders of activities to undertake; and alert the user as times approached for specific things (such as getting ready for work, leaving home for the bus, doing the washing today etc).

Emergency

The Emergency functionality is a key feature for self-supporting, independent living and obviously will be useful for other communities such as people who are older, those with early stage dementia and so on.

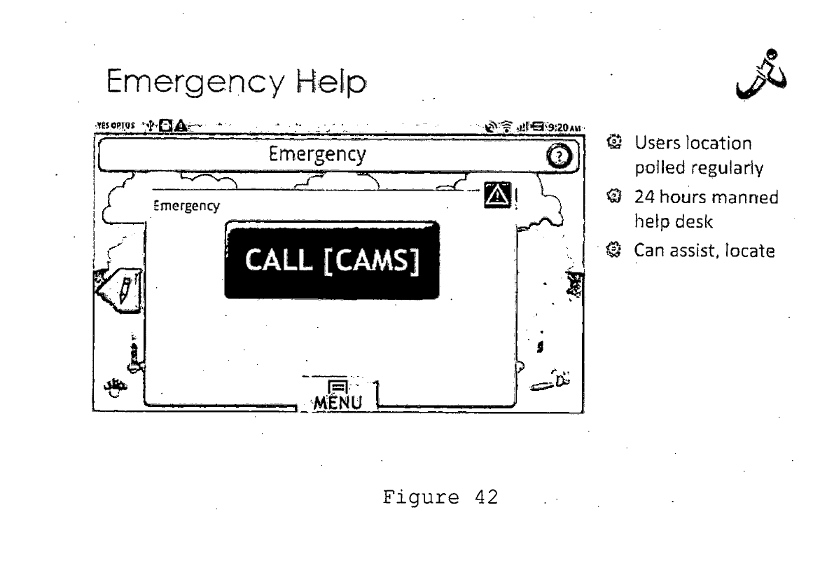

There is a clearly identified ‘emergency’ button on the screen of the handset (refer to FIG. 42). Once clicked, this immediately sends the user's GPS coordinates to Tracking HQ and initiates a call to Tracking HQ. The user's handset is then placed into loudspeaker mode so that the caller can hear a voice from HQ even if the unit is not held up to their ear.

Administration

The administration system is designed to be an online management system, which allows for the specific details for each user to be added, updated, reviewed and checked. There is a record for each individual user and this contains locations (home, work, friends, doctor—all as GPS coordinates); phone numbers (for same group, all identified with images or icons as well as names); transport routes (bus numbers and route connections); diary management (ability to create diary entries, reminders etc for user); and other enhancements (such as definition of walking routes to places, shopping lists, etc)

The system is designed so that information is stored in a secure back-end server. This is accessible (via a web service) in a secure manner to allow support networks or care personnel to update the details for the people that they support. These details include filling in the diary entries; sending messages to the person's handset; marking up the travel routes; adding contact (friends, work and medical support staff) and keeping the details used for the emergency function up to date.

In each case, the record for each individual will be available remotely (for families or staff) for updates, and a specific flag will be set specifying whether an individual is allowed to amend and update their system themselves, or whether the content could only be changed by authorised personnel. If the user is capable of making changes, these would be highlighted back to the responsible person (family member, carer or support personnel) for verification.

The Tracking Module

The tracking module is a centralised service—an extension of the administration module—which shows all users on a map interface, with the ability to look for specific users and review their current diary activities.

Any use of the emergency function on the service generates an immediate alert to the Tracking Interface—with the user highlighted (flashing), an audio alert of an emergency situation; in addition there is an incoming call from the handset (so that support could talk to and reassure the user).

As required, the Tracking HQ will dispatch support or emergency services to the location of the users. As long as the handset is in emergency mode, the GPS signal from the handset would be supplied every 30 seconds (otherwise, it would be on a 15 minute basis).

Tracking HQ is ultimately designed as a 24×7 monitoring centre. Tracking HQ will be the main site for administration functions including the updating of diaries, contact details, personal information etc for users of the system; as well as the central monitoring site.

Note: Tracking HQ would be set up as the first contact in the users devices for both SMS and calls through the mobile application. In this way, text messages as well as phone calls could be handled by Tracking HQ.

The application has been developed to provide as much functionality as possible in off-line mode (eg, stored maps, numbers, tasks and to-do lists) to remain as useful as possible, regardless of the location or circumstances of the user and handset. It will also allow for the addition of other modules and functionality, which will be delivered as over the air updates to the handset.

Web2Input from Multiple Sources

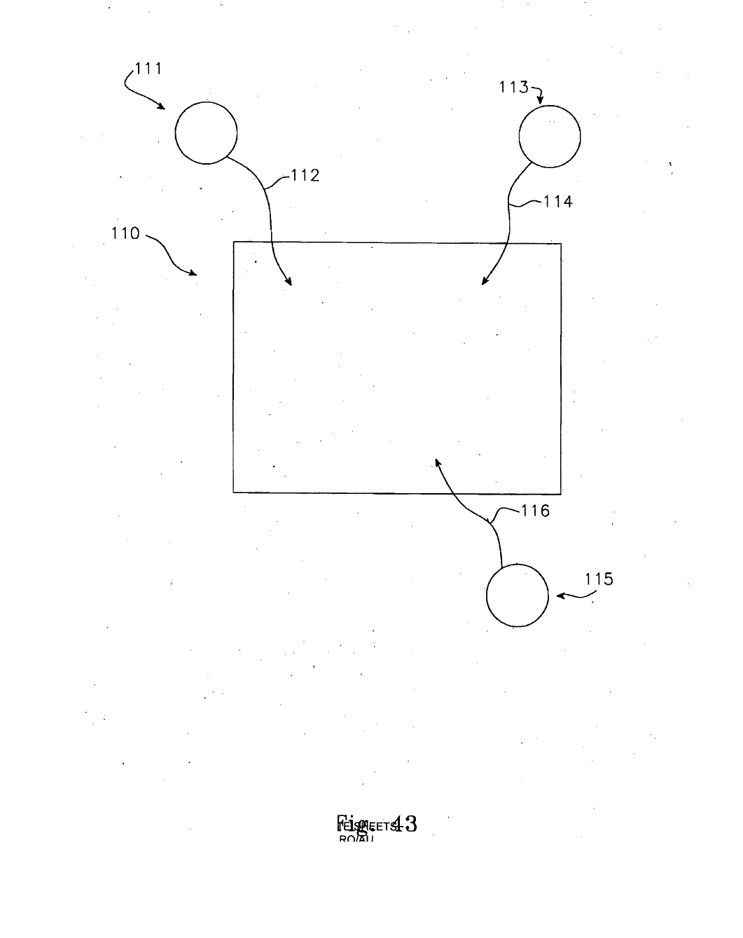

With reference to FIG. 43, there is illustrated conceptually a portal 110 which works in conjunction with the systems previously described. In this instance, multiple interest groups including interest group 111 can provide first input data 112 to the portal 110, second interest group 113 can provide second input data 114 to portal 110 and at least third interest group 115 can provide third input data 116 to portal 110. The data 112, 114, 116 can constitute information such as special interest information for example regarding gardening or football. The input can also come by way of rebranding of information available from other websites.

### AR-Like Presentation of Material

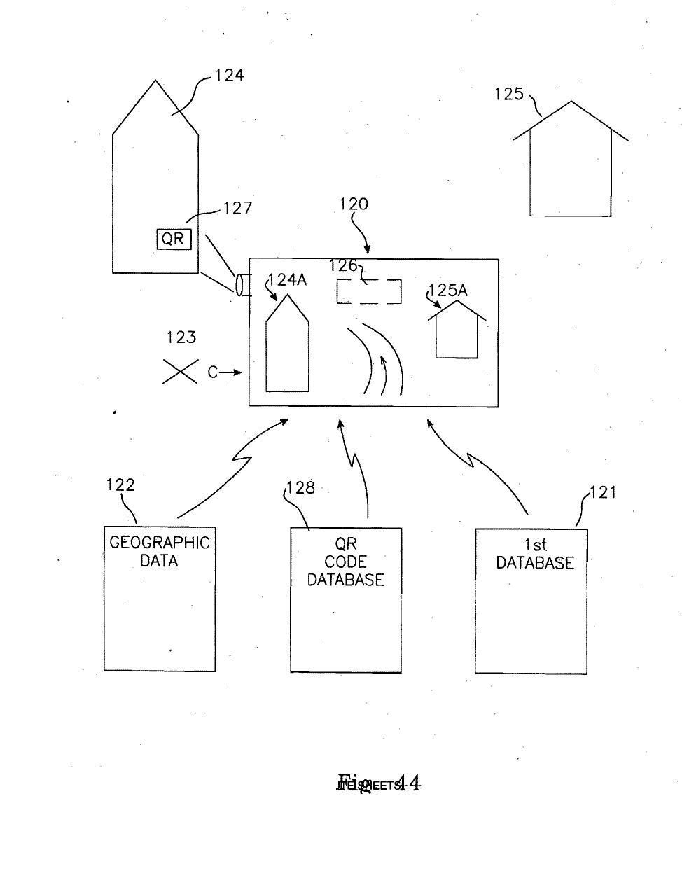

With reference to FIG. 44 there is illustrated a screenshot of a screen presenting information of the type previously described but where, in this instance, local information derived either directly from camera input on the handheld device or via a database of localised geographic information with which the handheld is in communication is overlayed. Specifically, with reference to FIG. 44, the handheld device 120 is in communication with first database 121 for provision of management information as previously described with reference to earlier embodiments in this specification. In addition to the handheld device 120 is in communication with a geographic data database 122 which provides geographic data to the handheld device 120 relevant to the geographic coordinates 123 against which the handheld device 120 is physically located at any given point in time. This allows for example an image of a first building 124 located to the left of geographic coordinates 123 to be rendered on a screen of handheld device 120 as image 124A and wherein the image data for image 124A is derived from geographic data located in geographic database 122. Similarly, building 125 located to the right of the geographic coordinates 123 has its image 125A rendered on the right hand side of the screen of the handheld device 120 whereby a user of the device can place themselves relatively on the screen 120 as being located between the buildings 124, 125. Additional data 126 can be overlayed on the image on the handheld device 120, the additional data 126 derived from the first database 121 thereby to assist and guide the use of the handheld device 120.

### QR Code Prompting

In an enhancement of the arrangement described above in relation to FIG. 44, the handheld device 120 may include the ability to read a QR code 127 located on building 124, for example by using a camera or like image acquisition device incorporated within the handheld device 120. The QR code causes related data to be derived from at least a third database 128 thereby to provide additional data on the screen of device 120 thereby to assist further the user of handheld device 120.

### Implementation Via a Mobile Virtual Network Operator System

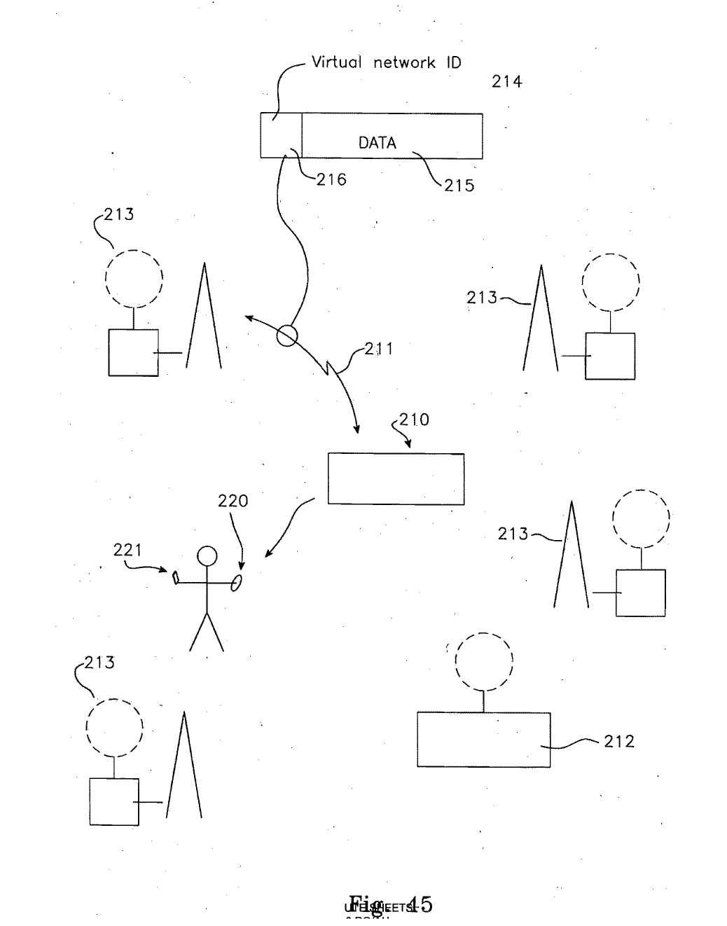

The mobile handheld device 210 as illustrated in FIG. 45 and otherwise generally of the type as described with reference to previous embodiments. Communications 211 from the mobile device 210 to control centre 212 passed via a mobile telephone communications system to control centre 212 via data packets 214. The data packets include communications data 215 and also virtual network identification data 216. The virtual network identification data identifies all data associated with users of handheld devices such device 210 and managed by the control centre 212 as data associated with the control centre 212 and, as such, is segregated from other data passing over the mobile or cellular telephone network 213. This permits the data packets 214 to be managed and charged for separately from any other data traffic on the mobile telephone network 213.

### Specialised Wrist Mount Device

With further reference to FIG. 45, one version of the communications device 210 can be incorporated as a wrist mount device 220 for releasable attachment to the wrist, for example, of a wearer. The specialised device 220 contains much of the functionality of the communications device 210 including mobile telephone capability, GPS location capability and a display for displaying information to the wearer 221. In this instance, the specialised device 220 can have an emergency alert function as its primary function (refer earlier description of the emergency alert features). An advantage of this arrangement is that unlike many emergency alert systems such as the vital call system, there is no limit to the geographic location over which the wearer can invoke the emergency function of the specialised device 220. The device can be monitored continuously at the control centre 212 and will function so long as it is in communication range of the mobile telephone network 213 or like communications network (for example in some instances, a satellite based communications system can be used to increase geographic coverage). Preferred embodiments of the communications device including device 210 and 220 thereby allow users freedom of movement not otherwise heretofore provided and “close the loop” between the training, their activity in the real world and the control centre 212.

Advantageously, the control centre 212 is a local or regional based centre thereby providing customised, highly attentive information to and monitoring of the user 221.

The above describes only some embodiments of the present invention and modifications, obvious to those skilled in the art, can be made thereto without departing from the scope and spirit of the present invention.

1. A handheld guide unit for extending the navigational capability of a disabled person; said unit including display means; prompt means related to time; said unit graded as a function of current disability profile of said disabled person.

2. A handheld guide unit for extending the navigational capability of a disabled person; said unit including display means; said unit including prompt means; the functionality of said unit graded as a function of current disability profile of said disabled person.

3. The unit of claim 2 including a communication device adapted to receive an application from a remote location.

4. The unit of claim 3, wherein said application includes a tracking application whereby data corresponding to the current location of the handheld guide unit is ascertained by said unit and transmitted to said remote location.

5. The handheld guide unit of claim 2, including a remote controlled device whereby command data sent from said remote location causes a predetermined command action on said handheld guide unit.

6. The handheld guide unit of claim 2, further including an emergency mode wherein upon manual activation of said emergency mode by a user, said unit displays data for communication to third parties who may assist said user.

7. The handheld guide unit of claim 2, in communication with a database at a remote location whereby a user of said handheld guide unit can interact with another like user operating a handheld guide unit thereby to interact in a peer-to-peer manner.

8. The handheld guide unit of claim 2, including a transport module which interfaces with a third party application located on a remote third party database.

9. The handheld guide unit of claim 2, wherein a user may import a picture either taken by the unit or imported from said database at a remote location and utilises the picture data as an icon displayed on a display of said handheld guide unit.

10. The handheld guide unit of claim 2, further including a “target achieved” input operable by said user whereby said user may input to said unit the achievement of a predetermined target event thereby, in turn, to prompt programmed next action by said handheld guide unit.

11. A virtual community output device for display of educational routines in a programmed sequence to a user.

12. The virtual community output device of claim 11, programmable in one of a selection of predetermined modes.

13. The output device of claim 12, wherein said modes include “Show me”, “Teach me” and “Let me do” mode.

14. The Virtual Community output device of claim 11, wherein display is varied to match the assessed ability of the viewer; said assessment based upon the input and interaction of the user.

15. A database system in communication with a virtual communications output device and at least one handheld guide unit; said system sharing at least some items of data between said Virtual Community output device and said handheld guide unit thereby to provide consistency of experience to a user following initial use of said Virtual Community output device and subsequent use of said handheld guide unit.

16. The database system of claim 15, wherein modules exhibited on said Virtual Community output device mirror modules exhibited on said handheld device.

17. A machine readable medium comprising program code executable on a processor of a handheld guide unit as claimed in claim 2.

18. A machine readable medium comprising program code executable on a processor of a Virtual Community output device as claimed in claim 11.

19. A virtual telecommunications network adapted for communication with the handheld guide unit as claimed in claim 1, incorporating a virtual network identifier insertion module in said handheld unit whereby data packets sent from said unit over a communications network include a virtual network identifier thereby to permit independent control and monitoring of said data packets with reference to said identifier.

20. The virtual communications network of claim 19, wherein a plurality of said units share a common network identifier thereby to group said data packets.

21. A virtual telecommunications network adapted for communication with the handheld guide unit as claimed in claim 2, incorporating a virtual network identifier insertion module in said handheld unit whereby data packets sent from said unit over a communications network include a virtual network identifier thereby to permit independent control and monitoring of said data packets with reference to said identifier.

22. The virtual communications network of claim 21, wherein a plurality of said units share a common network identifier thereby to group said data packets.
